(19) United States
(12) Patent Application Publication
(10) Pub. No.: US 2025/0150134 A1
(43) Pub. Date: May 8, 2025

(54) TECHNIQUES FOR TRAINING DEVICES FOR MACHINE LEARNING-BASED CHANNEL STATE INFORMATION AND CHANNEL STATE FEEDBACK

(71) Applicant: QUALCOMM Incorporated, San Diego, CA (US)

(72) Inventors: Chenxi HAO, Beijing (CN); Yuwei REN, Beijing (CN); Taesang YOO, San Diego, CA (US); Hao XU, Beijing (CN); Yu ZHANG, San Diego, CA (US); Rui HU, Beijing (CN); Wei XI, Beijing (CN); Ruiming ZHENG, Beijing (CN); Eren BALEVI, Brooklyn, NY (US); June NAMGOONG, San Diego, CA (US); Pavan Kumar VITTHALADEVUNI, San Diego, CA (US)

(21) Appl. No.: 18/837,806

(22) PCT Filed: Apr. 30, 2022
(86) PCT No.: PCT/CN2022/090818

§ 371 Date: Aug. 12, 2024

(51) Int. Cl. H04B 7/06; H04L 25/02; H04L 41/14; H04W 24/10

(52) U.S. Cl. CPC H04B 7/0626; H04L 25/0254; H04L 41/145; H04W 24/10

(57) ABSTRACT

Aspects described herein relate to using machine learning (ML) models for performing channel state information (CSI) encoding or decoding, CSI-reference signal (RS) optimization, channel estimation, etc. The ML models can be trained by a user equipment (UE), separately by the UE and a network node (e.g., base station), or jointly by the UE and network node.

### CLAIM OF PRIORITY UNDER 35 U.S.C. § 119

This application is a National Stage of International Patent Application No. PCT/CN2022/090818, filed on Apr. 30, 2022, and entitled “TECHNIQUES FOR TRAINING DEVICES FOR MACHINE LEARNING-BASED CHANNEL STATE INFORMATION AND CHANNEL STATE FEEDBACK,” the disclosure of which is incorporated herein in its entirety.

### BACKGROUND

Aspects of the present disclosure relate generally to wireless communication systems, and more particularly, to communicating channel state information (CSI)-reference signals (RSs) and CSI feedback.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In some wireless communication technologies, such as 5G NR, CSI feedback is supported where a first node, such as a network node (e.g., base station/gNB) can transmit CSI-reference signals (RSs), and a second node, such as a user equipment (UE), can receive the CSI-RS and transmit CSI feedback. For example, CSI feedback may specify a rank indicator (RI), precoding matrix indicator (PMI), channel quality indicator (CQI), etc. as feedback based on which the first node can update communication parameters for communicating with the second node.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method for wireless communication at a user equipment (UE) is provided that includes receiving, from a network node, a configuration for training a machine learning (ML) model for performing channel estimation or reporting channel state information, wherein the configuration indicates a data set for the ML model and one or more learning rate parameters, training, based on the configuration, the ML model, wherein the ML model performs at least one of performing, based on the ML model, channel estimation of a channel between the UE and the network node, or reporting, based on the ML model, channel state information of the channel between the UE and the network node.

According to another aspect, a method for wireless communication is provided that includes transmitting a configuration for training, at a UE, a ML model for performing channel estimation or reporting channel state information, wherein the configuration indicates a data set for the ML model and one or more learning rate parameters, and wherein the ML model is used for at least one of channel estimation of a channel between the UE and a network node or CSI reporting of the channel between the UE and the network node.

In another aspect, a method for wireless communication is provided that includes receiving, from a network node, a network-side ML model trained on a reference UE-side ML model for performing channel estimation or reporting channel state information, training a UE-side ML model using data received from a server and based on the network-side ML model, wherein the network-side ML model and UE-side ML model comprise at least one of the network-side ML model used for channel state information (CSI)-reference signal (RS) transmission and the UE-side ML model used for channel estimation, or the network-side ML model used for CSI decoding and the UE-side ML model used for CSI encoding

In another aspect, a method for wireless communication is provided that includes transmitting a network-side ML model trained on a reference UE-side ML model for performing channel estimation or reporting channel state information, and wherein the ML model is used for at least one of channel estimation of the channel between the UE and a network node or CSI reporting of the channel between a UE and the network node.

In further aspects, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 illustrates a flow chart of an example of a method for training a ML model at a UE for performing channel estimation or encoding CSI, in accordance with aspects described herein;

FIG. 6 illustrates an example of a process for periodically training the ML model at the UE, in accordance with aspects described herein;

FIG. 7 illustrates an example of a timeline for signaling between the UE and network node for performing periodic training/reporting, in accordance with aspects described herein;

FIG. 8 illustrates an example of a process for aperiodically training the ML model at the UE, in accordance with aspects described herein;

FIG. 9 illustrates examples of timelines for signaling between the UE and network node for performing aperiodic training/reporting, in accordance with aspects described herein;

FIG. 10 illustrates an example of a network for performing ML model training at a UE, in accordance with aspects described herein;

FIG. 11 illustrates an example of a network for performing ML model training at a UE server that can communicate the trained ML model or related parameters to a respective UE, in accordance with aspects described herein;

FIG. 12 illustrates a flow chart of an example of a method 1200 for using a ML model trained at a UE for performing channel estimation or encoding CSI, in accordance with aspects described herein;

FIG. 13 illustrates an example of a process for performing joint training the ML model at the UE for encoding CSI feedback, in accordance with aspects described herein;

FIG. 14 illustrates an example of a timeline for signaling between the UE and network node for performing periodic training or reporting of a joint ML model for encoding or decoding CSI feedback, in accordance with aspects described herein;

FIG. 15 illustrates examples of timelines for signaling between the UE and network node for performing aperiodic training or reporting of a joint ML model for encoding or decoding CSI feedback, in accordance with aspects described herein;

FIG. 16 illustrates a flow chart of an example of method for performing joint training the ML model at the network for decoding CSI feedback, in accordance with aspects described herein;

FIG. 17 illustrates an example of a network for performing joint ML model training of a CSI encoder at a UE and a CSI decoder at a network node, in accordance with aspects described herein;

FIG. 18 illustrates an example of a process for performing joint training the ML model at the UE for performing channel estimation, in accordance with aspects described herein;

FIG. 19 illustrates an example of a timeline for signaling between the UE and network node for performing periodic training or reporting of a joint ML model for transmitting CSI-RS or performing channel estimation, in accordance with aspects described herein;

FIG. 20 illustrates examples of timelines for signaling between the UE and network node for performing aperiodic training or reporting of a joint ML model for transmitting CSI-RS or performing channel estimation, in accordance with aspects described herein;

FIG. 21 illustrates a flow chart of an example of method for performing joint training the ML model at the network for transmitting CSI-RS, in accordance with aspects described herein;

FIG. 22 illustrates an example of a network for performing joint ML model training of a CSI-RS transmitter at a network node and a channel estimation at a UE, in accordance with aspects described herein;

FIG. 23 illustrates a flow chart of an example of a method for using an ML model trained at a UE for performing channel estimation or encoding CSI, in accordance with aspects described herein;

FIG. 24 illustrates a flow chart of an example of a method for using a ML model trained at a network node for performing CSI-RS transmission or decoding CSI, in accordance with aspects described herein;

FIG. 25 illustrates an example of a network for performing separate ML model training of a CSI decoder at a network node and a CSI encoder at a UE, in accordance with aspects described herein;

FIG. 26 illustrates an example of a network for performing separate ML model training of a cover code for transmitting CSI-RS at a network node and a channel estimation at a UE, in accordance with aspects described herein; and

FIG. 27 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to supporting machine learning (ML)-based channel state information (CSI)-reference signal (RS) transmission, channel estimation, CSI feedback, etc. In some examples, training strategies are presented for training ML-based (e.g., artificial intelligence (AI)-based) CSI feedback and CSI-RS optimization. In accordance with examples described herein, training of an ML model for CSI feedback, CSI-RS, channel estimation, etc., can occur at one node (e.g., at a user equipment (UE)), where results of the training can be forwarded to another node (e.g., a network node, such as a base station/gNB) with assistance at the other node (e.g., base station/gNB can send the aggregated gradients back to UEs). In other examples, training of an ML model can occur separately at the nodes (e.g., separately at a UE and then network node, or the opposite), or can occur jointly at the nodes (e.g., at both the UE and network node), where results may be updated among the nodes, etc. In some examples, where the nodes share training data, an air-interface or signaling in the wireless communication technology, such as fifth generation (5G) new radio (NR), can be modified to accommodate the signaling.

Some examples described herein can provide AI/ML-based CSF, where the UE can perform CSI compression (e.g., CSI encoding) and report the CSI compression to the network node using a small number of bits. In this example, the network side (e.g., a base station/gNB) can perform CSI decompression (e.g., CSI decoding) to recover the reported CSI. Other examples described herein provide AI/ML-based CSI-RS optimization, where the network side (e.g., a base station/gNB) can perform optimized CSI-RS transmission (e.g., CSI-RS compression) based on transmitting low-density CSI-RS with an optimized cover-code or beamforming (e.g., Nt ports on L<Nt resource elements (REs) per resource block (RB), transmit on K RBs among total N RBs (K<N)). In this example, the UE side can perform channel estimation to recover the full channel of the Nt ports on N RBs.

Aspects described herein relate to, in the above examples, performing training for AI/ML model on one or both sides. For example, training function on UE side only (e.g., for federated learning) can be robust, but may lack UE differentiation. In another example, separate or sequential training function at both UE and gNB sides may be less robust, but may allow for UE differentiation. In any case, using AI/ML-based algorithms for CSI feedback and CSI compression can facilitate improved communication of CSI parameters and/or may reduce the signaling requirements for reporting improved CSI parameters. This can improve receiving of communications at the UE, where the scheduling grant can be generated to schedule resources based on channel state observed by the UE. In addition, this can improve the quality of communications by enabling optimal scheduling of resources, accordingly conserving communication resources, etc., which can accordingly improve user experience when using the UE.

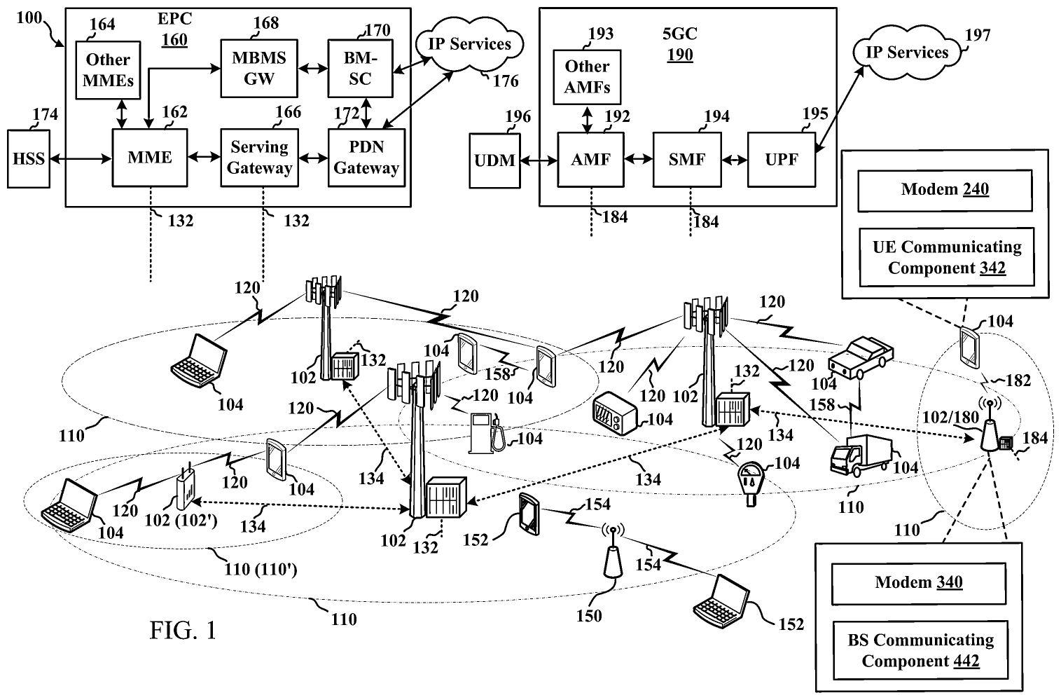

The described features will be presented in more detail below with reference to FIGS. 1-27.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include network entities 102, also referring to herein as base stations 102, including one or more components of a disaggregated base station, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and UE communicating component 342 for performing CSI encoding or channel estimation based on a ML model, in accordance with aspects described herein. In addition, some nodes may have a modem 340 and BS communicating component 442 for decoding CSI or transmitting CSI-RS based on an ML model, in accordance with aspects described herein. Though a UE 104 is shown as having the modem 240 and UE communicating component 342 and a base station 102/gNB 180 is shown as having the modem 340 and BS communicating component 442, this is one illustrative example, and substantially any node or type of node may include a modem 240 and UE communicating component 342 and/or a modem 340 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an SI interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The network entity or base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, in a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.), including base station 102 described above and further herein, may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as virtually distributing functionality for at least one unit, which can enable flexibility in network design. The various units of the disaggregated base station, or disaggregated RAN architecture, can be configured for wired or wireless communication with at least one other unit.

In an example, UE communicating component 342 can perform CSI encoding or channel estimation based on a ML model that can be trained or received by the UE (e.g., alone or in conjunction with the base station 102 training a ML model). Similarly, in an example, BS communicating component 442 can perform CSI decoding or CSI-RS transmission based on a ML model that can be trained or received by the base station 102. In one example, UE communicating component 342 can train the ML model and can report the ML model or related parameters to the base station 102. In another example, UE communicating component 342 and BS communicating component 442 can each separately train a ML model (e.g., using similar parameters or data sets), such that the models can be similar. In yet another example, UE communicating component 342 and BS communicating component 442 can jointly train a same ML model, and can report the ML model or related parameters to one another for updating.

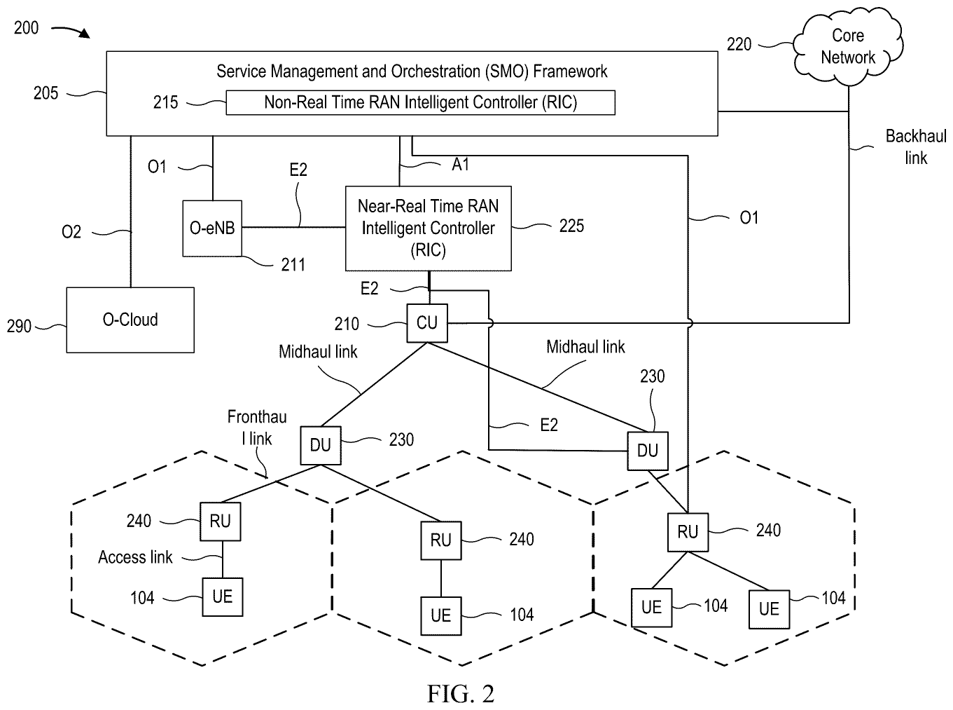

FIG. 2 shows a diagram illustrating an example of disaggregated base station 200 architecture, wherein, as noted above, one or more components of which may be included when the terms network entity or a base station are used herein. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

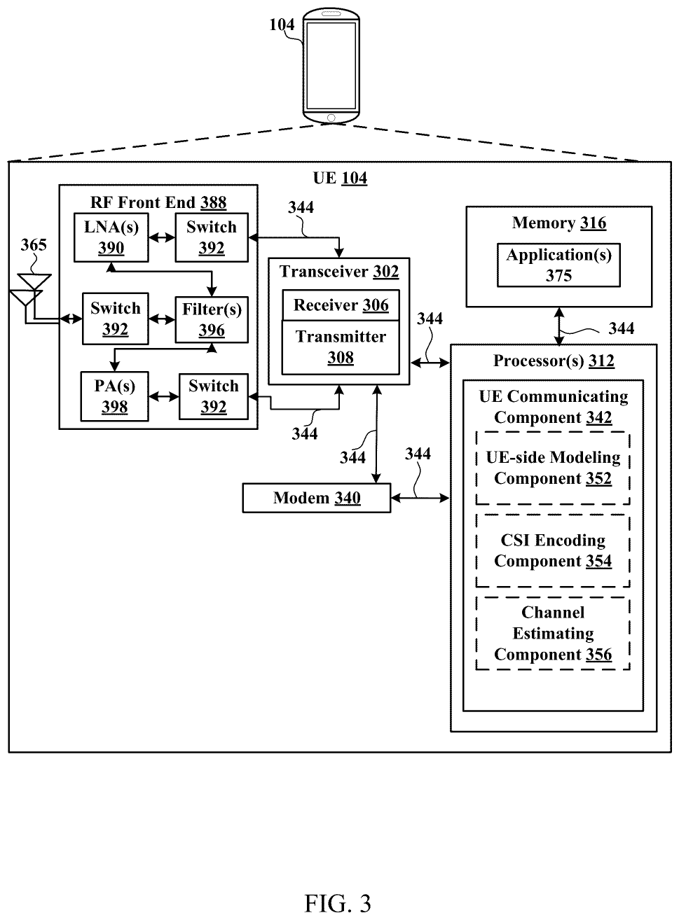

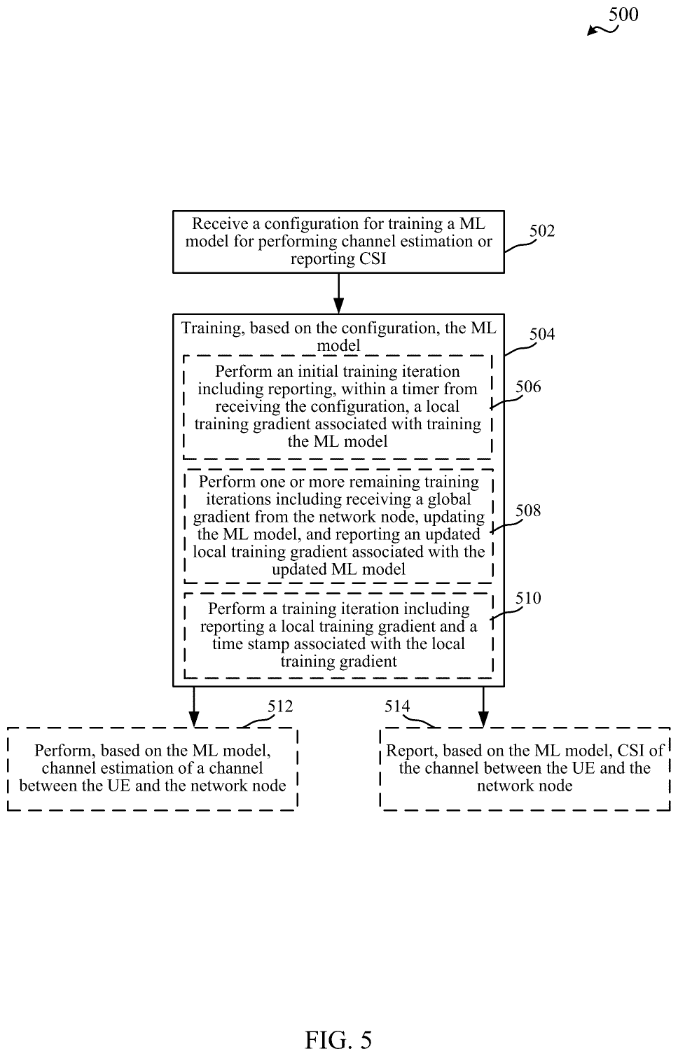

Turning now to FIGS. 3-27, aspects are depicted with reference to one or more components and one or more methods that may perform the actions or operations described herein, where aspects in dashed line may be optional. Although the operations described below in FIGS. 5, 6, 9, 12, 13, 16, 18, 21, 23, 24 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for transmitting encoded CSI and assistance information for ML-based CSI operations, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a UE-side modeling component 352 for using or training a ML model at the UE 104 for use in CSI encoding or channel estimation, a CSI encoding component 354 for encoding CSI using a ML model, and/or a channel estimating component 356 for performing channel estimation using a ML model, in accordance with aspects described herein.

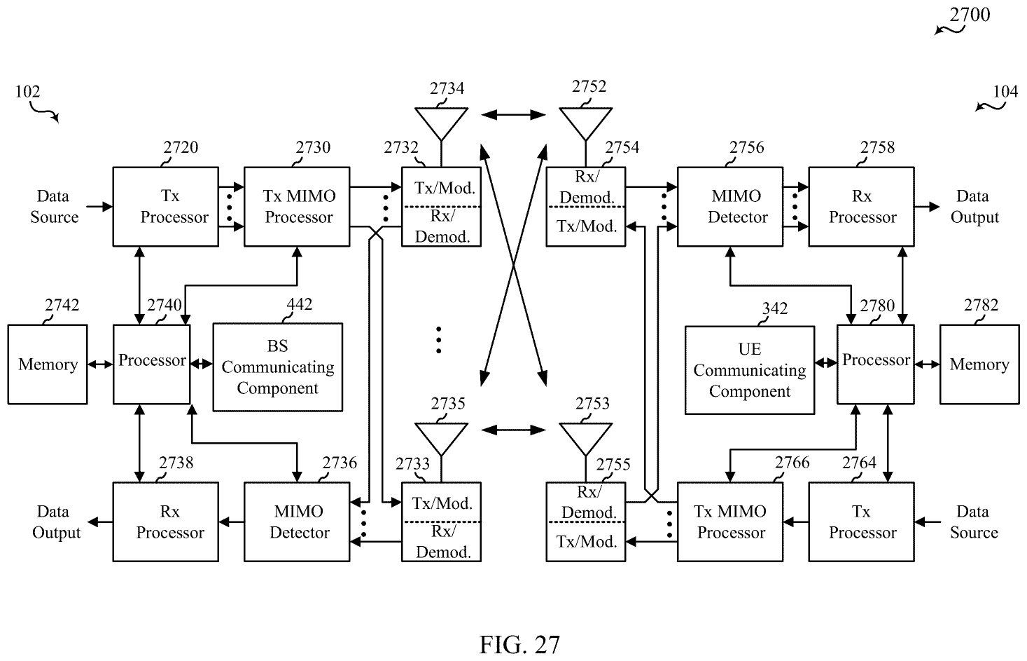

In an aspect, the processor(s) 312 may correspond to one or more of the processors described in connection with the UE in FIG. 27. Similarly, the memory 316 may correspond to the memory described in connection with the UE in FIG. 27.

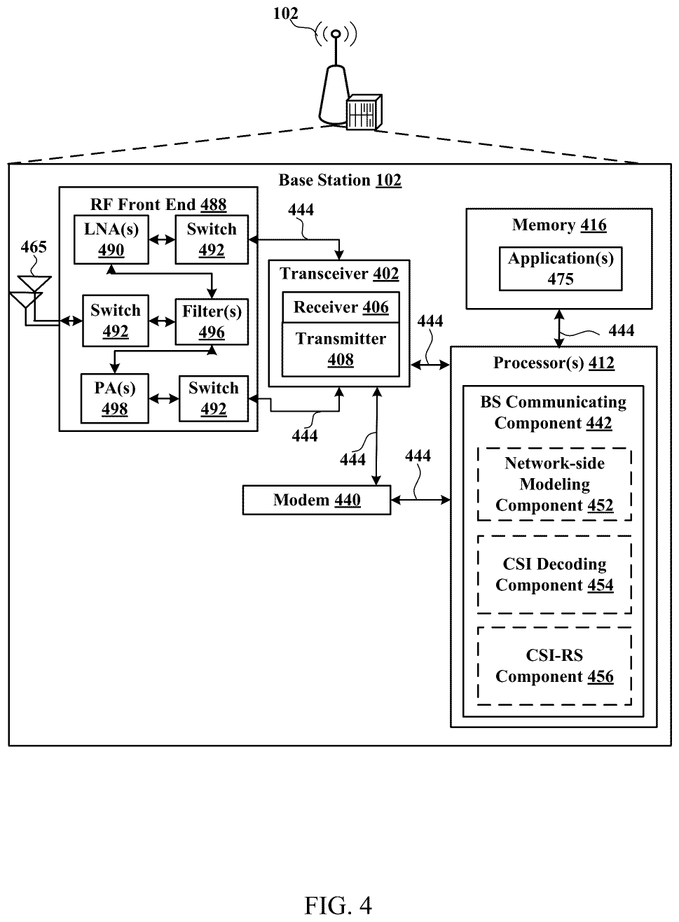

Referring to FIG. 4, one example of an implementation of base station 102 (e.g., a base station 102 and/or gNB 180, a monolithic base station, one or more components of a disaggregated base station, etc., as described above) may include a variety of components, some of which have already been described above, but including components such as one or more processors 412 and memory 416 and transceiver 402 in communication via one or more buses 444, which may operate in conjunction with modem 440 and BS communicating component 442 for receiving encoded CSI and assistance information for ML-based CSI operations, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a network- side modeling component 452 for using or training a ML model for performing CSI decoding or CSI-RS transmission, a CSI decoding component 454 for decoding CSI feedback received from a UE based on a ML model, and/or a CSI-RS component 456 for transmitting CSI-RS based on a ML model, in accordance with aspects described herein.

In an aspect, the processor(s) 412 may correspond to one or more of the processors described in connection with the base station in FIG. 27. Similarly, the memory 416 may correspond to the memory described in connection with the base station in FIG. 27.

### UE-Side ML Model Training With Gradients Exchange With Network Node

FIG. 5 illustrates a flow chart of an example of a method 500 for training a ML model at a UE for performing channel estimation or encoding CSI, in accordance with aspects described herein. In an example, a UE 104 can perform the functions described in method 500 using one or more of the components described in FIGS. 1 and 3.

In method 500, at Block 502, a configuration for training a ML model for performing channel estimation or reporting CSI can be received. In an aspect, UE-side modeling component 352, e.g., in conjunction with processor(s) 312, memory 316, transceiver 302, UE communicating component 342, etc., can receive the configuration for training (and/or reporting) the ML model for performing channel estimation or reporting CSI. For example, UE-side modeling component 352 can receive the configuration from a network node (e.g., base station 102, a portion of a disaggregated base station, etc.), which may include receiving the configuration in a RRC or other higher layer signaling from the network node. For example, the configuration may include parameters for performing, at the UE 104, ML model training of the model for performing channel estimation or encoding CSI. In one example, the configuration may indicate data set indices for performing the ML model training, a batch size (b) or number of epochs (N) for performing ML model training, a learning rate configuration, which may include one or more parameters such as an initial learning rate, a learning rate decaying type (e.g., fixed, exponential, step, cosine, etc.), a decaying ratio, and/or the like. In one example, the UE 104 may choose batch size and may report the batch size back to the network node. In another example, the network node can select the number of epochs and can stop training at the UE 104 (e.g., send a trigger to the UE to stop training) where the number of epochs is attained. For example, receiving the configuration can include receiving an initial configuration for performing ML model training, receiving an updated gradient/model from the network node for using as or with the ML model, etc.

In method 500, at Block 504, the ML model can be trained based on the configuration. In an aspect, UE-side modeling component 352, e.g., in conjunction with processor(s) 312, memory 316, transceiver 302, UE communicating component 342, etc., can train, based on the configuration, the ML model. For example, UE-side modeling component 352 can train the ML model using the data set indices received in the configuration, using the batch size (b) or number of epochs (N) received in the configuration or otherwise determined by the UE, using the learning rate configuration received in the configuration from the network node, etc. For example, UE-side modeling component 352 can perform periodic training and/or periodic communication of training results, which may include synchronized federated training with other UEs served by the network node. In another example, UE-side modeling component 352 can perform aperiodic training and/or aperiodic communication of training results, which may include asynchronized federated training.

In one example, training the ML model at Block 504 can optionally include, at Block 506, performing an initial training iteration including reporting, within a timer form receiving the configuration, a local training gradient associated with training the ML model. In an aspect, UE-side modeling component 352, e.g., in conjunction with processor(s) 312, memory 316, transceiver 302, UE communicating component 342, etc., can perform the initial training iteration including reporting, within the timer from receiving the configuration, the local training gradient associated with training the ML model, which can be as part of synchronized federated training. For example, UE-side modeling component 352 can perform ML model training based on receiving the configuration or receiving an indication to activate ML model training (e.g., from the network node), or based on receiving a global gradient from the network node (e.g., for subsequent training iterations).

In an example, the UE 104 can receive a global gradient from the network node (which may be an aggregated gradient that is computed based on local gradients from multiple UEs) as part of the configuration received at Block 502, as described. In an example, the timer within which the UE is to report the local training gradient can be defined from the end of receiving the global gradient reception (e.g., at time t₀) to the beginning of the gradient/model reporting (e.g., at time t₁). If the time from t₀ to t₁ is larger than the timer, UE-side modeling component 352 may refrain from reporting the local gradient/model obtained from training the ML model at the UE 104. As described further herein, the network node can collect the local gradient/model from each UE the reports within the timer, which may include UE 104, and can provide a global gradient to all UEs served by the network node for performing channel estimation or encoding CSI.

As such, in one example, training the ML model at Block 504 can optionally include, at Block 508, performing one or more remaining training iterations including receiving a global gradient from the network node, updating the ML model, and reporting an updated local training gradient associated with the updated ML model. In an aspect, UE-side modeling component 352, e.g., in conjunction with processor(s) 312, memory 316, transceiver 302, UE communicating component 342, etc., can perform the one or more remaining training iterations including receiving a global gradient from the network node, updating the ML model, and reporting an updated local training gradient associated with the updated ML model. For example, UE-side modeling component 352 can continue to refine the ML model based on receiving the global gradient, performing additional training of its ML model, and periodically providing any updated local training gradient or related parameters to the network node according to the timer or other defined period.

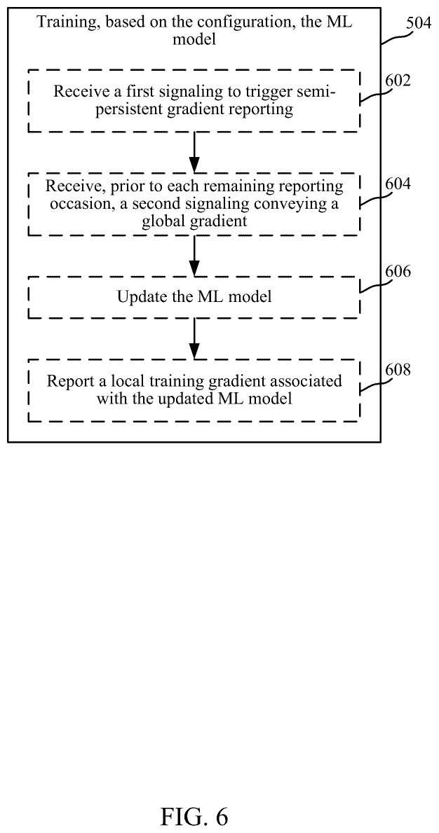

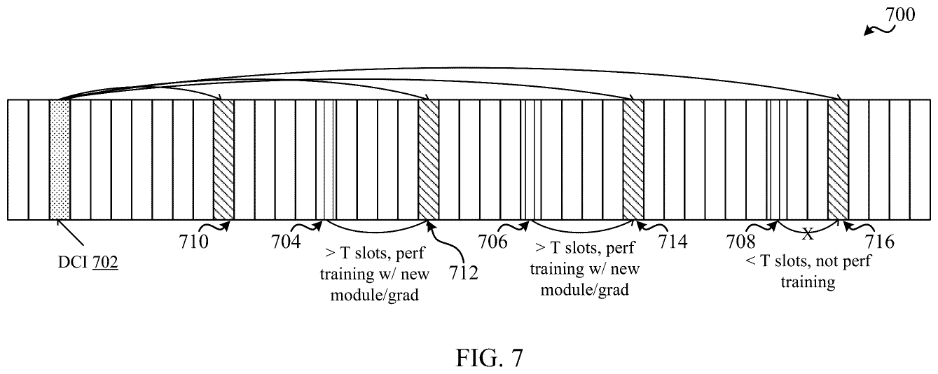

FIG. 6 illustrates an example of a process for periodically training the ML model at the UE. In particular, for example, FIG. 6 illustrates additional Blocks for training, based on the configuration, the ML model, as described in Block 504 in FIG. 5. FIG. 7 illustrates an example of a timeline 700 for signaling between the UE and network node for performing periodic training/reporting.

In training the ML model at Block 504, optionally at Block 602, a first signaling to trigger semi-persistent gradient reporting can be received. In an aspect, UE-side modeling component 352, e.g., in conjunction with processor(s) 312, memory 316, transceiver 302, UE communicating component 342, etc., can receive (e.g., from the network node) the first signaling to trigger or activate semi-persistent gradient reporting. For example, UE-side modeling component 352 can receive the first signaling as dedicated downlink control information (DCI) (e.g., DCI 702 in timeline 700).

In training the ML model at Block 504, optionally at Block 604, prior to each remaining reporting occasion, a second signaling conveying a global gradient can be received. In an aspect, UE-side modeling component 352, e.g., in conjunction with processor(s) 312, memory 316, transceiver 302, UE communicating component 342, etc., can receive (e.g., from the network node), prior to each remaining reporting occasion (e.g., after a first iteration), the second signaling conveying the global gradient. For example, UE-side modeling component 352 can receive the second signaling at slots 704, 706, 708 in timeline 700, including the global gradient computed by the network node based on various received local training gradients.

In training the ML model at Block 504, optionally at Block 606, the ML model can be updated. In an aspect, UE-side modeling component 352, e.g., in conjunction with processor(s) 312, memory 316, transceiver 302, UE communicating component 342, etc., can update the ML model based on the received global gradient, which can include refining the ML model and generating another local training gradient associated with the updated ML model.

In training the ML model at Block 504, optionally at Block 608, a local training grant associated with the updated ML model can be reported. In an aspect, UE-side modeling component 352, e.g., in conjunction with processor(s) 312, memory 316, transceiver 302, UE communicating component 342, etc., can report (e.g., to the network node) the local training gradient associated with the updated ML model. For example, UE-side modeling component 352 can report the local training gradient at the periodic intervals indicated in the downlink DCI 702, including slots 710, 712, and 714. In one example, if there is not enough timing gap between the first or second signaling and each reporting occasion, the UE may not be expected to perform a new training or update the local gradient. For example, the downlink DCI 702 can also indicate slot 716 for reporting the local training gradient, however, UE-side modeling component 352 can refrain from performing ML model training when the global gradient is received less than a number of slots (T) before the local training gradient is to be reported. In this example, the global gradient can be received in slot 708, which is less than T slots before reporting slot 716, and UE-side modeling component 352 can accordingly determine to not train the ML model based on the global gradient and/or to not report the local training gradient in slot 716.

Referring back to FIG. 5, in another example, training the ML model at Block 504 can optionally include, at Block 510, performing a training iteration including reporting a local training gradient and a timestamp associated with the local training gradient. In an aspect, UE-side modeling component 352, e.g., in conjunction with processor(s) 312, memory 316, transceiver 302, UE communicating component 342, etc., can perform the training iteration including reporting the local training gradient and the timestamp associated with the local training gradient (e.g., to the network node), which can be as part of an asynchronized federated training. For example, UE-side modeling component 352 can perform ML model training based on receiving the configuration or receiving an indication to activate ML model training (e.g., from the network node), or based on receiving a global gradient from the network node.

In an example, the UE 104 can receive the global gradient as part of the configuration received at Block 502, as described. Based on performing the ML model training at the UE 104, UE-side modeling component 352 can report the timestamp at which the ML model training is performed or completed, and the network node can use the timestamp in computing a global gradient (e.g., by weighting local gradients/models received from multiple UEs based on the associated timestamp). For example, the network node may apply higher weight to local gradients/models having newer timestamps. In an example, UE-side modeling component 352 can report the timestamp as a slot index when receiving a global gradient from the network node, based on which the UE-side modeling component 352 performs the ML model training and produces the reported local training gradient. In another example, UE-side modeling component 352 can report the timestamp as an iteration index where the UE-side modeling component 352 performs the ML model training and produces the reported local training gradient. In another example, UE-side modeling component 352 can report the timestamp as a dedicated timestamp received from the network node together with the global gradient based on which the UE-side modeling component 352 performs the ML model training and produces the reported local training gradient.

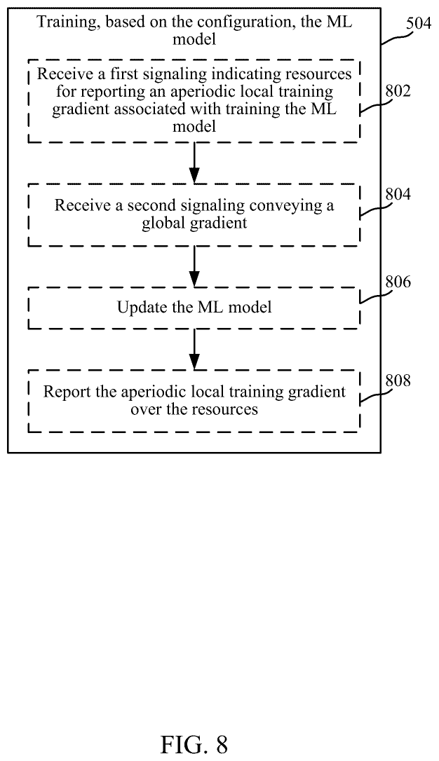

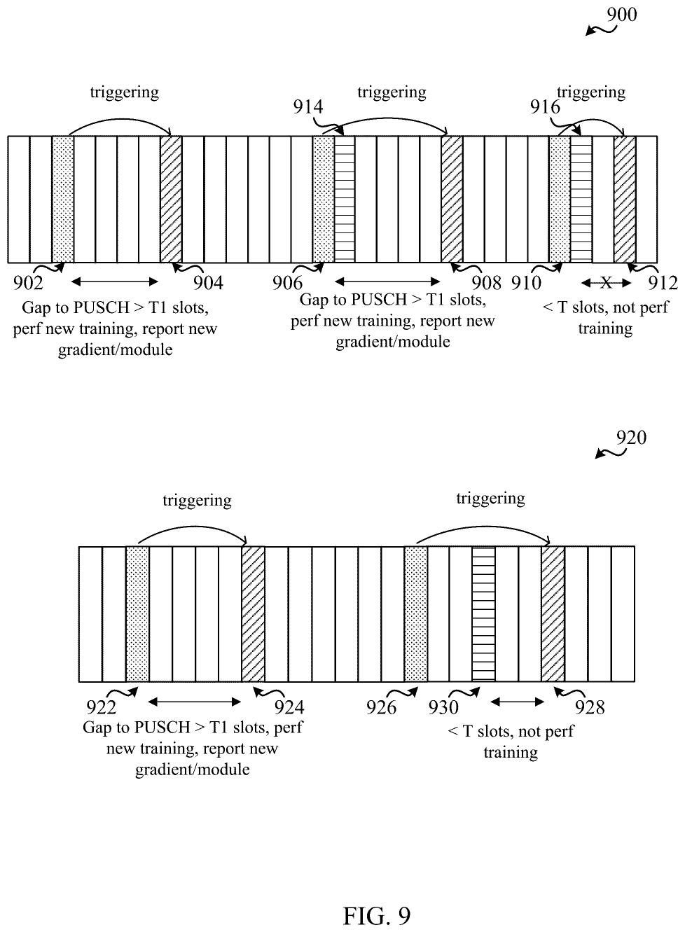

FIG. 8 illustrates an example of a process for aperiodically training the ML model at the UE. In particular, for example, FIG. 8 illustrates additional Blocks for training, based on the configuration, the ML model, as described in Block 504 in FIG. 5. FIG. 9 illustrates examples of timelines 900 and 920 for signaling between the UE and network node for performing aperiodic training/reporting.

In training the ML model at Block 504, optionally at Block 802, a first signaling indicating resources for reporting an aperiodic local training gradient associated with training the ML model can be received. In an aspect, UE-side modeling component 352, e.g., in conjunction with processor(s) 312, memory 316, transceiver 302, UE communicating component 342, etc., can receive (e.g., from the network node) the first signaling indicating resources for reporting the aperiodic local training gradient associated with training the ML model. For example, UE-side modeling component 352 can receive the first signaling including DCI 902 indicating resources or slot 904 for reporting a local training gradient, DCI 906 indicating resources or slot 908 for reporting a local training gradient, DCI 910 indicating resources or slot 912 for reporting a local training gradient in timeline 900, and/or can receive the DCI 922 indicating resources or slot 924 for reporting a local training gradient, DCI 926 indicating resources or slot 928 for reporting a local training gradient in timeline 920. In this example, each training iteration can include a reporting on a physical uplink shared channel (PUSCH) activated/triggered by a first signaling (e.g., a dedicated DCI). The offset of the PUSCH relative to the DL-DCI can satisfy the timing for model training. If not enough time, as described above, the UE may not be expected to perform a new training or update the local gradient. In addition, for example, the DL-DCI may be scrambled by a dedicated radio network temporary identifier (RNTI) for indicating model training (and thus the UE-side modeling component 352 can determine to perform ML model training and report a local training gradient based on the RNTI indicated in the DCI).

In training the ML model at Block 504, optionally at Block 804, a second signaling conveying a global gradient can be received. In an aspect, UE-side modeling component 352, e.g., in conjunction with processor(s) 312, memory 316, transceiver 302, UE communicating component 342, etc., can receive (e.g., from the network node) a second signaling conveying a global gradient. For example, UE-side modeling component 352 can receive the second signaling at slots 914, 916 in timeline 900, and/or at slot 930 in timeline 920, including the global gradient computed by the network node based on various received aperiodic local training gradients. For example, the second signaling can include physical downlink shared channel (PDSCH) signaling.

In training the ML model at Block 504, optionally at Block 806, the ML model can be updated. In an aspect, UE-side modeling component 352, e.g., in conjunction with processor(s) 312, memory 316, transceiver 302, UE communicating component 342, etc., can update the ML model based on the received global gradient, which can include refining the ML model and generating another local training gradient associated with the updated ML model.

In training the ML model at Block 504, optionally at Block 808, an aperiodic local training grant can be reported over the resources. In an aspect, UE-side modeling component 352, e.g., in conjunction with processor(s) 312, memory 316, transceiver 302, UE communicating component 342, etc., can report (e.g., to the network node) the aperiodic local training gradient (e.g., associated with the updated ML model) over the resources indicated in the DCI. In addition, for example, UE-side modeling component 352 can report the aperiodic local training gradient along with the timestamp and/or other parameters (e.g., batch size). For example, UE-side modeling component 352 can report the local training gradient at resources 904, 906, 924, as described above. However, the UE-side modeling component 352 can refrain from performing ML model training when the global gradient is received less than a number of slots (T) before the local training gradient is to be reported. In this example, the global gradient can be received in slot 916, which is less than T slots before reporting slot 912 in timeline 900, and UE-side modeling component 352 can accordingly determine to not train the ML model based on the global gradient and/or to not report the local training gradient in slot 912. Similarly, in timeline 920, the global gradient can be received in slot 930, which is less than T slots before reporting slot 928, and UE-side modeling component 352 can accordingly determine to not train the ML model based on the global gradient and/or to not report the local training gradient in slot 928.

In method 500, optionally at Block 512, channel estimation of a channel between the UE and the network node can be performed based on the ML model. In an aspect, channel estimating component 356, e.g., in conjunction with processor(s) 312, memory 316, transceiver 302, UE communicating component 342, etc., can perform channel estimation of the channel between the UE and the network node based on the ML model. For example, channel estimating component 356 can perform channel estimation of a channel with from the network node (e.g., a wireless environment between the UE and network node). In an example, the network node can transmit the CSI-RS as a pilot, based on which the UE can measure the channel. For example, the network node can use ML model to transmit low-overhead CSI-RS, and channel estimating component 356 can use an ML model to measure the channel based on the received CSI-RS. In an example, the AI/ML based CSI-RS optimization and its channel estimation include determining an optimized cover-code or beamforming that multiplexes a number, Nt, or CSI-RS ports on L<Nt REs per RB and transmits the Nt ports on K out of N RBs, and the channel estimating component 356 can recover the Nt ports on all N RBs. Channel estimating component 356 can perform the channel estimation based on the CSI-RS to recover the full channel of a number of ports on a number of RBs.

In method 500, optionally at Block 514, CSI of a channel between the UE and the network node can be reported based on the ML model. In an aspect, CSI encoding component 354, e.g., in conjunction with processor(s) 312, memory 316, transceiver 302, UE communicating component 342, etc., can report, based on the ML model, the CSI of the channel between the UE and the network node. For example, CSI encoding component 354 can perform CSI encoding using the ML model to compress the CSI and report the compressed CSI with a number of bits, which can be less than the number of bits for typical uncompressed CSI reporting.

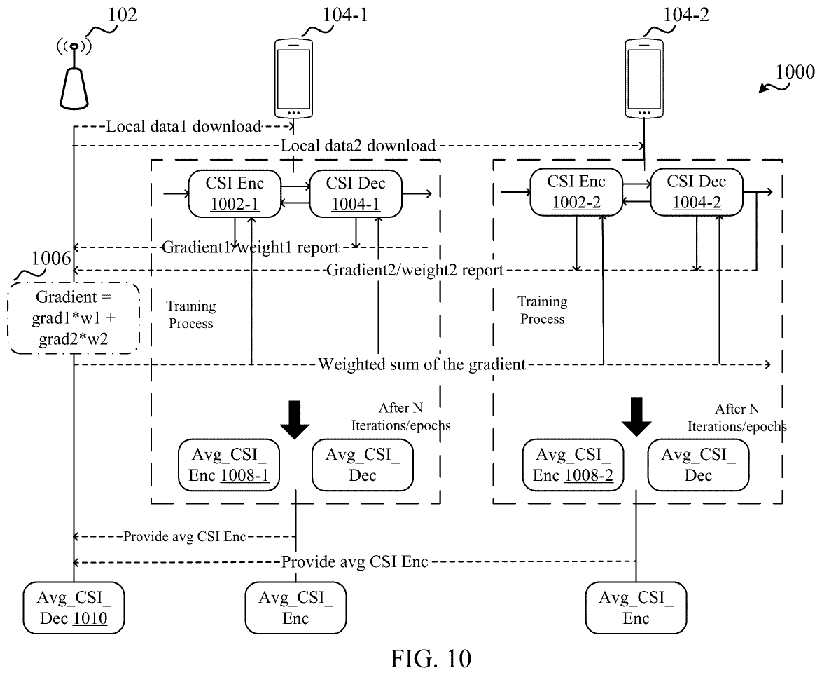

FIG. 10 illustrates an example of a network 1000 for performing ML model training at a UE. Network 1000 includes a base station 102 that can communicate with UEs 104-1, 104-2. UEs 104-1 and 104-2 can perform UE-side ML model training and report results to the base station 102, which can include the periodic or aperiodic training and/or reporting described above. UE 104-1 can include a CSI encoding process 1002-1 and a CSI decoding process 1004-1. UE 104-2 can include a CSI encoding process 1002-2 and a CSI decoding process 1004-2. The base station 102 can transmit the configuration described above (e.g., in Block 502) to UE 104-1 and UE 104-2. In an example, UE 104-1 and UE 104-2 can download local data from a server. UEs 104-1 and 104-2 can independently train their own ML models for their respective CSI encoding process 1002-1 or 1002-2 and a CSI decoding process 1004-1 or 1004-2, and can respectively report gradients to the base station 102. The base station 102 can compute a global gradient at 1006, which may include weighting the received local gradients based on timestamp for aperiodic training and/or reporting. The base station 102 can provide the global gradient back to the UEs 104-1 and 104-2 for respectively applying to the ML models for CSI encoding process 1002-1 and 1002-2 or CSI decoding process 1004-1 and 1004-2. After a number of iterations (N) or epochs, the ML model training can be considered completed, and the UEs 104-1 and 104-2 can respectively report the average CSI encoders 1008-1 and 1008-2 to the base station 102, which can compute an average CSI decoder 1010 to use in decoding CSI from the UEs 104-1 and 104-2.

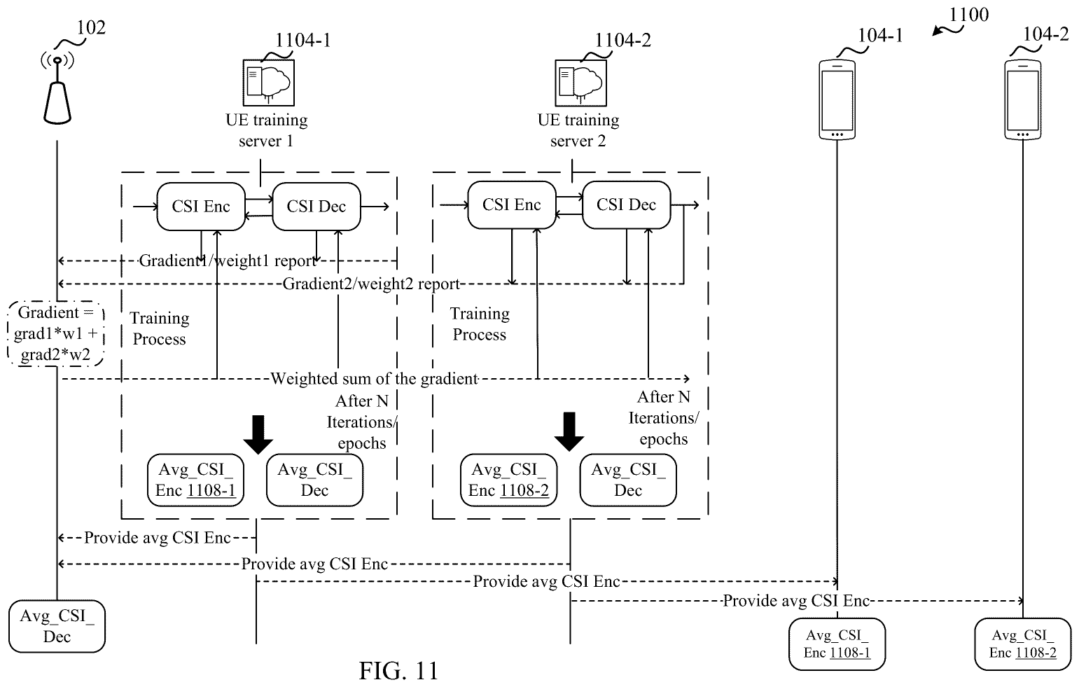

FIG. 11 illustrates an example of a network 1100 for performing ML model training at a UE server that can communicate the trained ML model or related parameters to a respective UE. Network 1100 can include a base station 102 that communicate with UEs 104-1, 104-2, and/or corresponding UE servers 1104-1, 1104-2. For example, the UE servers 1104-1, 1104-2 can perform certain functions on behalf of the UEs 104-1, 104-2 to offload processing from the UEs 104-1, 104-2. As such, for example, the UE servers 1104-1, 1104-2 can communicate with the UEs 104-1, 104-2, or base station 102 directly, to receive information, process the information, and provide output (e.g., to the UEs 104-1, 104-2). As described above with reference to FIG. 10, the UE servers 1104-1, 1104-2 can respectively perform the ML model training on behalf of UEs 104-1, 104-2, to generate average CSI encoders 1108-1, 1108-2, and transmit the average CSI encoders to the UEs 104-1, 104-2.

Using federated learning with model/gradient exchange, as described, can use less workload at a given UE. For example, each UE or UE server can calculate a gradient per batch, and send the gradient and batch size back to the base station. Alternatively, each UE or UE server updates the model per batch/epoch based on local data/activation, and can send the updated model and batch size back to gNB. The training can be processed via local data at the UE. The base station can aggregate gradient/model from multiple UEs, and compute a global gradient (e.g., a sum or weighted sum) and broadcast the global gradient back to the multiple UEs. As described, for example, the weight maybe based on one or more of the batch size of each UE or the time-stamp of the model received from each UE or the index of iteration. For training at UE server, the UE server may deliver the trained model to UEs.

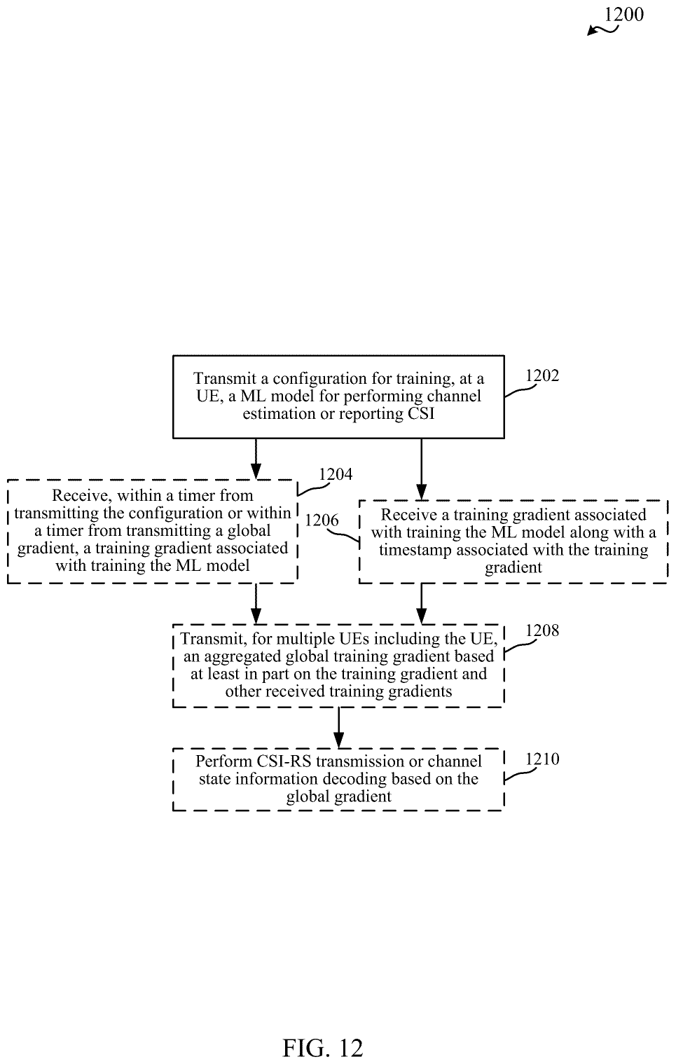

FIG. 12 illustrates a flow chart of an example of a method 1200 for using a ML model trained at a UE for performing channel estimation or encoding CSI, in accordance with aspects described herein. In an example, a network node, such as a base station 102 (e.g., a monolithic base station, one or more components of a disaggregated base station, etc.) can perform the functions described in method 1200 using one or more of the components described in FIGS. 1 and 4.

In method 1200, at Block 1202, a configuration for training, at a UE, a ML model for performing channel estimation or reporting CSI can be transmitted. In an aspect, network-side modeling component 452, e.g., in conjunction with processor(s) 412, memory 416, transceiver 402, BS communicating component 442, etc., can transmit the configuration for training (and/or reporting), at the UE, the ML model for performing channel estimation or reporting CSI. As described, for example, network-side modeling component 452 can transmit the configuration in a RRC or other higher layer signaling to the UE 104. For example, the configuration may include parameters for performing, at the UE 104, ML model training of the model for performing channel estimation or encoding CSI. In one example, the configuration may indicate data set indices for performing the ML model training, a batch size (b) or number of epochs (N) for performing ML model training, a learning rate configuration, which may include one or more parameters such as an initial learning rate, a learning rate decaying type (e.g., fixed, exponential, step, cosine, etc.), a decaying ratio, and/or the like. In one example, the UE 104 may choose batch size and may report the batch size back to the network node. In another example, the network-side modeling component 452 can select the number of epochs and can stop training at the UE 104 (e.g., send a trigger to the UE to stop training) where the number of epochs is attained. For example, transmitting the configuration can include transmitting an initial configuration for performing ML model training, transmitting an updated gradient/model for using as or with the ML model, etc.

In method 1200, optionally at Block 1204, a training gradient associated with training the ML model can be received within a timer from transmitting the configuration or within a timer from transmitting a global gradient. In an aspect, network-side modeling component 452, e.g., in conjunction with processor(s) 412, memory 416, transceiver 402, BS communicating component 442, etc., can receive, within the timer from transmitting the configuration or within the timer from transmitting the global gradient, the training gradient associated with training the ML model. For example, network-side modeling component 452 can configure multiple UEs to periodically perform ML model training and reporting of local gradients for use in determining a global gradient to be used in the ML models at the UEs 104. For a set of UEs that report the local gradient/model within the timer, network-side modeling component 452 may compute the global (aggregated) the gradient and send to the set of UEs even if the timer has not expired. For example, network-side modeling component 452 can compute the global (aggregated) gradient as x̅=Σ_{k∈U}xₖ·bₖ, where xₖ is the gradient/model reported by user k, bₖ is the weight and can be dependent on the batch size applied by user k. In another example, if timer expires and one or more UEs in the set does not report the local gradient/model, network-side modeling component 452 can compute the aggregated gradient based on the received local gradient/models and send it to the UEs in the set. In this example, network-side modeling component 452 can compute the global (aggregated) gradient as x̅=Σ_{k∈U′}xₖ·bₖ, where xₖ is the gradient/model reported by user k, bₖ is the batch size applied by user k, U′ is the set of UEs reporting the local gradient/model within the timer.

In method 1200, optionally at Block 1206, a training gradient associated with training the ML model can be received along with a timestamp associated with the training gradient. In an aspect, network-side modeling component 452, e.g., in conjunction with processor(s) 412, memory 416, transceiver 402, BS communicating component 442, etc., can receive the training gradient associated with training the ML model along with a timestamp associated with the training gradient. For example, network-side modeling component 452 can configure multiple UEs to aperiodically perform ML model training and reporting of local gradients for use in determining a global gradient to be used in the ML models at the UEs 104, which can allow for a more flexible UE implementation as the UE can determine when to perform ML model training. For example, network-side modeling component 452 can compute the global (aggregated) gradient based on receiving local training gradients reported by one or more UE reports, and can send back the computed global gradient. For example, at time t, the global (aggregated) gradient can be given by x̅_{new}=x̅ₜ·(1−Σ_{k ∈U′}αₖ)+Σ_{k∈U′}xₖ·αₖ, where αₖ=f(bₖ, Tₖ), where Tₖ is the timestamp and bₖ is the batch size. As described, for example, the timestamp can be one or more of the slot index when receiving the global (aggregated) gradient based on the which the ML model training is performed at the UE, the iteration index where the ML model training is performed at the UE, a dedicated time- stamp transmitted to the UE by the network-side modeling component 452 together with the global (aggregated) gradient based on the which the UE performs ML model training, etc.

In method 1200, optionally at Block 1208, an aggregated global training gradient can be transmitted for multiple UEs, including the UE, based at least in part on the training gradient and other received training gradients. In an aspect, network-side modeling component 452, e.g., in conjunction with processor(s) 412, memory 416, transceiver 402, BS communicating component 442, etc., can transmit, for multiple UEs including the UE, the aggregated global training gradient based at least in part on the training gradient and the other received training gradients (from other UEs).

In an example, network-side modeling component 452 can transmit the configuration in a DCI, as described above in reference to FIGS. 7 and 9, which can include an indication of resources for transmitting the local training gradient, whether multiple periodic resources defined in one DCI, a single resource for aperiodic reporting, etc. In addition, for example, network-side modeling component 452 can receive the local training gradients from the UEs over the indicated resources and/or can transmit the global gradient in certain resources, as shown in FIGS. 7 and 9. Moreover, as described, if the global gradient is not transmitted to one or more UEs in time for the UE(s) to train the ML model and provide another local training gradient, the UE(s) may not be expected to provide the local training gradient in the indicated resources.

In method 1200, optionally at Block 1210, CSI-RS transmission or CSI decoding can be performed based on the global gradient. In an aspect, CSI-RS component 456 or CSI decoding component 454, e.g., in conjunction with processor(s) 412, memory 416, transceiver 402, BS communicating component 442, etc., can perform CSI-RS transmission or CSI decoding based on the global gradient. For example, network-side modeling component 452 can use a ML model at the network node that can be updated based on the global gradient, or can receive an average CSI encoder output or channel estimation output from one or more UEs that is determined based on a ML model at the UE that is updated using the global gradient. In any case, in an example, CSI-RS component 456 can perform CSI-RS transmission of a low density CSI-RS (e.g., lower density than of ML modeling is not used) using a cover code or beamforming that can be optimized based on the global gradient. For example, the CSI-RS can include Nt ports on L<Nt REs per RB, transmitted on K RBs among total N RBs (K<N). In another example, CSI decoding component 454 can decode or decompress CSI received from one or more UEs based on the global gradient, as described.

### Joint ML Model Training

Communications between the UE 104 and network node can be similar for UE-side ML modeling, as described above, and joint ML model training. For example, the UE 104 can receive the configuration indicating parameters for training the ML model and can train the ML model, as described in Blocks 502 and 504 of method 500 in FIG. 5. As part of the training process in Block 504, a UE performing joint ML model training for encoding CSI can give encoder output to a network node, which can calculate loss and use the loss to calculate a gradient to update its CSI decoder and give the updated gradient back to the UE so the UE can update its encoder. In addition, the network node performing joint ML model training for transmitting CSI-RS can give its CSI-RS transmission output to a UE, the UE can calculate loss, use the loss to calculate a gradient to update its channel estimator, and give the gradient back to the network node so the network node can update its CSI-RS transmitter.

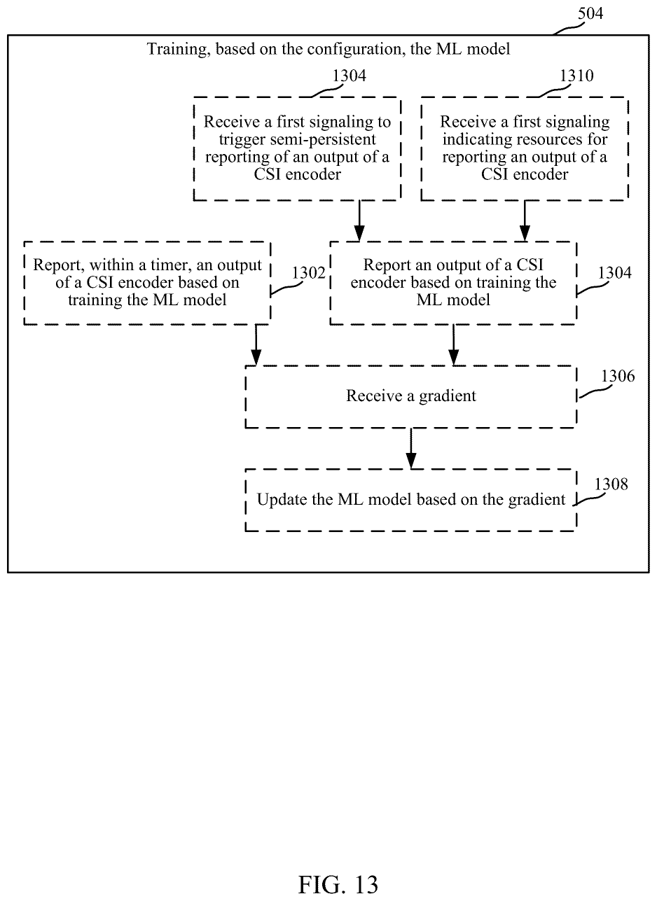

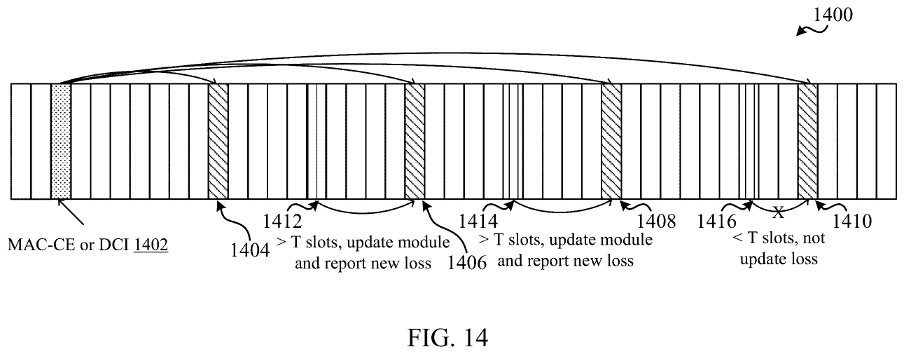

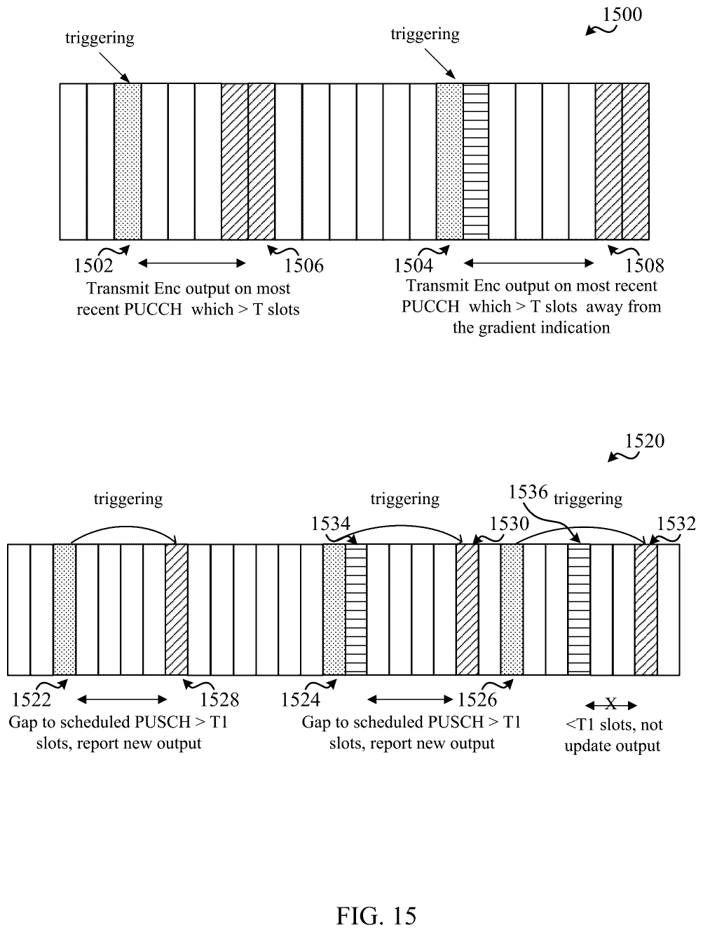

FIG. 13 illustrates an example of a process for performing joint training the ML model at the UE for encoding CSI feedback. In particular, for example, FIG. 13 illustrates additional Blocks for training, based on the configuration, the ML model, as described in Block 504 in FIG. 5. FIG. 14 illustrates an example of a timeline 1400 for signaling between the UE and network node for performing periodic training or reporting of a joint ML model for encoding or decoding CSI feedback. FIG. 15 illustrates examples of timelines 1500, 1520 for signaling between the UE and network node for performing aperiodic training or reporting of a joint ML model for encoding or decoding CSI feedback.

In training the ML model at Block 504, optionally at Block 1302, an output of a CSI encoder based on training the ML model can be reported within a timer. In an aspect, UE-side modeling component 352, e.g., in conjunction with processor(s) 312, memory 316, transceiver 302, UE communicating component 342, etc., can report, within the timer, the output of the CSI encoder based on training the ML model. Upon receiving command of training process activation or upon receiving a global gradient, UE-side modeling component 352 can forward a batch of data set and report the output of its CSI encoder to the network node within the timer. The timer can be defined from the end of the gradient/training activation reception t₀ to the beginning of the CSI encoder output reporting t₁. If the time from t₀ to t₁ is larger than the timer, UE-side modeling component 352 may refrain from reporting its local CSI encoder output, as described further herein

In another example, in training the ML model at Block 504, optionally at Block 1304, a first signaling to trigger semi-persistent reporting of an output of a CSI encoder can be received. In an aspect, UE-side modeling component 352, e.g., in conjunction with processor(s) 312, memory 316, transceiver 302, UE communicating component 342, etc., can receive (e.g., from the network node) the first signaling to trigger semi-persistent reporting of an output of a CSI encoder. For example, UE-side modeling component 352 can receive the first signaling as media access control (MAC)-control element (CE) or dedicated DCI (e.g., MAC-CE or DCI 1402 in timeline 1400), which can indicate periodic resources for reporting output of the CSI encoder (e.g., in resources or slots 1404, 1406, 1408, 1410 in timeline 1400).

In training the ML model at Block 504, optionally at Block 1304, an output of a CSI encoder can be reported based on training the ML model. In an aspect, UE-side modeling component 352, e.g., in conjunction with processor(s) 312, memory 316, transceiver 302, UE communicating component 342, etc., can report an output of a CSI encoder based on training the ML model, where the output may include encoding results of the CSI encoder, which can be used to compute loss, as described further herein. For example, UE-side modeling component 352 can report the CSI reporting using a batch of a pre-logged data set, where an n-th iteration can be the n-th batch. In an example, UE-side modeling component 352 can determine the batch size, and can report the batch size to the network node. In addition, for example, UE-side modeling component 352 can report the output of the CSI encoder using physical uplink control channel (PUCCH), which may be configured in training process configuration (e.g., as received at Block 502), or PUSCH as scheduled by the DCI, as described above. For example, if the report is on PUCCH, a dedicated PUCCH resource can be associated; alternatively, a list of candidate PUCCH resources can be configured, and selected PUCCH resource can be conveyed by the activation/triggering.

In training the ML model at Block 504, optionally at Block 1306, a gradient can be received. In an aspect, UE-side modeling component 352, e.g., in conjunction with processor(s) 312, memory 316, transceiver 302, UE communicating component 342, etc., can receive (e.g., from the network node) the gradient. For example, the gradient can be calculated based on a loss associated with the CSI encoder output from one or more UEs. For example, UE-side modeling component 352 can receive the gradient at slots 1412, 1414, 1416 in timeline 1400, including the gradient computed by the network node based on various received CSI encoder outputs from various UEs. In one example, UE-side modeling component 352 can receive the gradient in MAC-CE or other higher layer signaling.

In one example, however, UE-side modeling component 352 can refrain from performing ML model training or CSI encoder output reporting when the gradient is received less than a number of slots (T) before the output of the CSI encoder is to be reported. In an example, where the gradient is received in slot 1416, which is less than T slots before reporting slot 1410, UE-side modeling component 352 can accordingly determine to not train the ML model based on the gradient and/or to not report the output of the CSI encoder in slot 1410.

In training the ML model at Block 504, optionally at Block 1308, the ML model can be updated based on the gradient. In an aspect, UE-side modeling component 352, e.g., in conjunction with processor(s) 312, memory 316, transceiver 302, UE communicating component 342, etc., can update the ML model based on the gradient, which can include refining the ML model for the CSI encoder and generating another CSI encoder output, which can be reported to the network node, as described above. In this regard, the UE can continue to train the ML model at the UE-side and report the CSI encoder output to allow the network node to train a network-side ML model and output the gradient for updating the UE-side ML models. In one example, UE-side modeling component 352 can performs model update using the gradient. The learning rate used for model update can be determined per training process setting or indicated by the network node in the configuration or the activation/triggering command (e.g., in MAC-CE or DCI 1402).

In another example, training the UE-side ML model and/or reporting CSI encoder output can be aperiodic. In this example, in training the ML model at Block 504, optionally at Block 1310, a first signaling indicating resources for reporting an output of a CSI encoder can be received. In an aspect, UE-side modeling component 352, e.g., in conjunction with processor(s) 312, memory 316, transceiver 302, UE communicating component 342, etc., can receive (e.g., from the network node) the first signaling indicating resources for reporting the output of the CSI encoder. For example, UE-side modeling component 352 can receive the first signaling as MAC-CE or dedicated DCI. In any case, for example, UE-side modeling component 352 can report the output of the CSI encoder over the resources (e.g., at Block 1304), as described above.

For example, referring to timeline 1500 where reporting is over PUCCH, the first signaling can include MAC-CE or DCI 1502, 1504 in timeline 1500, which can indicate PUCCH resources, and UE-side modeling component 352 can determine to report CSI encoder output on the PUCCH resources that are at least T slots away (e.g., respectively in slots 1506, 1508).

In another example, referring to timeline 1520 where reporting is over PUSCH, the first signaling can include MAC-CE or DCI 1522, 1524, 1526 in timeline 1520, which can respectively indicate resources or slots 1528, 1530, 1532 for reporting output of the CSI encoder. In this example, each iteration can be activated/triggered by the first signaling. The first iteration can be activated and/or triggered by the training process activation/triggering (e.g., by receiving the configuration at Block 502).

In this example, optionally at Block 1304, the output of the CSI encoder can be reported, as described above. The reporting content can include the CSI computed using a batch of the pre-logged data set. The batch index may be also indicated via the first signaling. UE-side modeling component 352 can determine the batch size, and can report the batch size to the network node. In addition, in this example, optionally at Block 1306, the gradient can be received, as described above. For the second to the remaining iterations, the indication of the gradient for the UE to update the UE-side ML model, is also received by the UE via a second signaling. In addition, in this example, optionally at Block 1308, the UE can update its ML model based on the gradient. In an example, UE-side modeling component 352 can use a learning rate for updating the ML model that is determined per training process setting or indicated by the network node in the activation/triggering command (e.g., in the configuration at Block 502 or otherwise in MAC-CE/DCI that triggers CSI encoder output reporting).

In this example of aperiodic reporting, where the UE-side modeling component 352 reports the CSI encoder output on PUCCH, UE-side modeling component 352 can report the CSI encoder output on the most recent occasion of configured PUCCH that satisfies a timeline for model training (in terms of symbols after the activation/triggering command, as described above in reference to timeline 1500). Where UE-side modeling component 352 can report on PUSCH, the activation/triggering can be via a DL-DCI, which schedules a PUSCH carrying the CSI encoder output report (as described above in reference to timeline 1520). In this example, the offset of the PUSCH relative to the DL-DCI can satisfy the timing for ML model training, as described above. This is shown, for example, for slot 1530, where the gradient is received at slot 1534, which is at least T1 slots from the reporting slot 1530, and UE-side modeling component 352 can accordingly report the CSI encoder output at slot 1530. Otherwise if timing not satisfied, UE-side modeling component 352 can refrain from updating the ML model and/or reporting the CSI encoder output. This is shown, for example, for slot 1532, where the gradient is received at slot 1536, which is less than T1 slots from the reporting slot 1532, and UE-side modeling component 352 can accordingly refrain from model training and/or reporting the CSI encoder output at slot 1532. In addition, for example, the DL-DCI may be scrambled by a dedicated RNTI for ML model training.

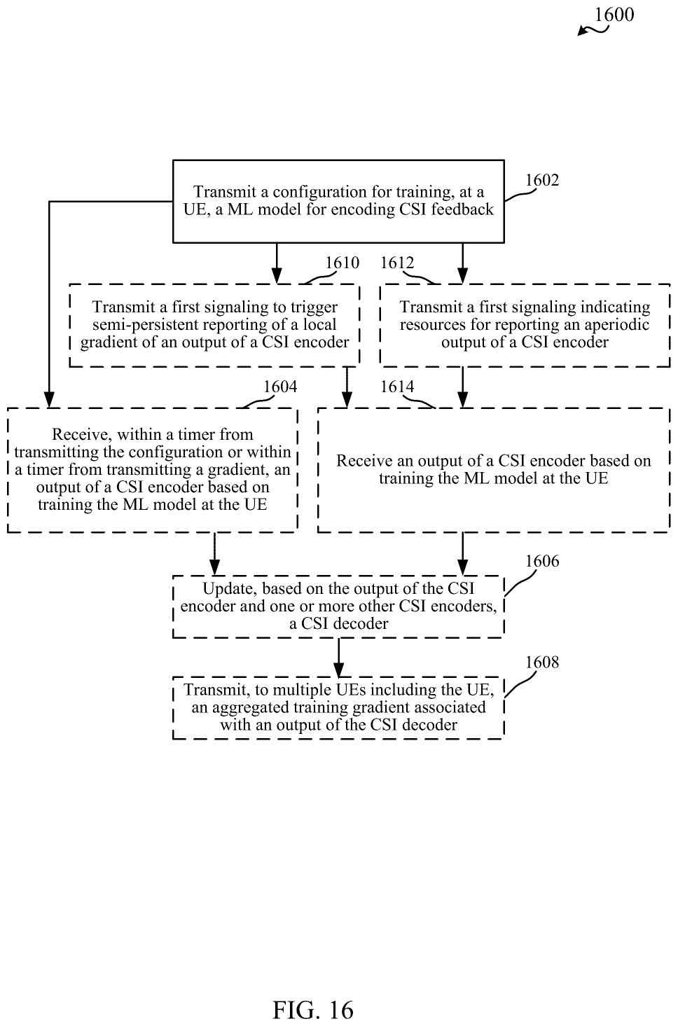

FIG. 16 illustrates a flow chart of an example of method 1600 for performing joint training the ML model at the network for decoding CSI feedback, in accordance with aspects described herein. In an example, a network node, such as a base station 102 (e.g., a monolithic base station, one or more components of a disaggregated base station, etc.) can perform the functions described in method 1600 using one or more of the components described in FIGS. 1 and 4.

In method 1600, at Block 1602, a configuration for training, at a UE, a ML model for encoding CSI feedback can be transmitted. In an aspect, network-side modeling component 452, e.g., in conjunction with processor(s) 412, memory 416, transceiver 402, BS communicating component 442, etc., can transmit the configuration for training, at the UE (e.g., UE 104), the ML model for encoding CSI feedback, as described in Block 1202 of the method 1200 of FIG. 12.

In one example, the network-side modeling component 452 can receive CSI encoder outputs from at least a portion of a set of UEs within a timer, and can use these CSI encoder outputs to train the network-side ML model, update a corresponding CSI decoder, and/or generate an associated gradient, as described. As described, for example, if all UEs in the set of UEs report the local CSI encoder output within the timer, network-side modeling component 452 can aggregate the CSI encoder outputs from all the UEs in the set to compute the loss/gradient even where the timer has not expired. In another example, if the timer expires and one or more UEs in the set of UEs does not report the output of the CSI encoder, the network-side modeling component 452 can aggregate, to compute the loss/gradient, the CSI encoder outputs from the UEs who report within the timer.

In method 1600, optionally at Block 1604, an output of a CSI encoder that is based on training the ML model at the UE can be received within a timer from transmitting the configuration or within a timer from transmitting a gradient. In an aspect, network-side modeling component 452, e.g., in conjunction with processor(s) 412, memory 416, transceiver 402, BS communicating component 442, etc., can receive, within the timer from transmitting the configuration or within the timer from transmitting the gradient, the output of the CSI encoder that is based on training the ML model at the UE. For example, network-side modeling component 452 can receive the CSI encoder output over a PUCCH, which may be configured in training process configuration (e.g., as transmitted at Block 1602), or PUSCH as scheduled by the DCI, as described above. For example, if the loss report is on PUCCH, a dedicated PUCCH resource can be associated; alternatively, a list of candidate PUCCH resources can be configured, and selected PUCCH resource can be conveyed by the activation/triggering.

In method 1600, optionally at Block 1606, a CSI decoder can be updated based on the output of the CSI encoder and one or more other CSI encoders. In an aspect, CSI decoding component 454, e.g., in conjunction with processor(s) 412, memory 416, transceiver 402, BS communicating component 442, etc., can update, based on the output of the CSI encoder and one or more other CSI encoders, the CSI decoder. For example, network-side modeling component 452 can receive multiple outputs of CSI encoders from multiple UEs within the timer, and can aggregate the outputs for updating the CSI decoder of the network node. CSI decoding component 454 can use the updated CSI decoder in decoding CSI received from the UEs, as described herein.

In method 1600, optionally at Block 1608, an aggregated training gradient associated with an output of the CSI decoder can be transmitted to multiple UEs including the UE. In an aspect, network-side modeling component 452, e.g., in conjunction with processor(s) 412, memory 416, transceiver 402, BS communicating component 442, etc., can transmit, to the multiple UEs including the UE (e.g., UE 104), the aggregated training gradient associated with the output of the CSI decoder (as updated in Block 1608). For example, network-side modeling component 452 can transmit the gradient at slots 1412, 1414, 1416 in timeline 1400, as described, which may be transmitted using MAC-CE or other higher layer signaling.

In method 1600, optionally at Block 1610, a first signaling to trigger semi-persistent reporting of an output of a CSI encoder can be transmitted. In an aspect, network-side modeling component 452, e.g., in conjunction with processor(s) 412, memory 416, transceiver 402, BS communicating component 442, etc., can transmit (e.g., to the UE 104) the first signaling to trigger semi-persistent reporting of an output of a CSI encoder. For example, network-side modeling component 452 can transmit the first signaling as MAC-CE or dedicated DCI, as described above (e.g., in reference to timeline 1400 of FIG. 14). For example, the reporting occasion can be pre-determined and/or periodic. In an example, network-side modeling component 452 can transmit first signaling for triggering/activation, and/or second signaling to indicate the gradient for UE to update the model for its CSI encoder.

In another example, training the network-side ML model and/or receiving CSI encoder output reporting can be aperiodic, as described. In method 1600, optionally at Block 1612, a first signaling indicating resources for reporting of an aperiodic output of a CSI encoder can be transmitted. In an aspect, network-side modeling component 452, e.g., in conjunction with processor(s) 412, memory 416, transceiver 402, BS communicating component 442, etc., can transmit (e.g., to the UE 104) the first signaling indicating resources for reporting an aperiodic output of a CSI encoder.

In method 1600, optionally at Block 1614, the output of the CSI encoder that is based on training the ML model at the UE can be received. In an aspect, network-side modeling component 452, e.g., in conjunction with processor(s) 412, memory 416, transceiver 402, BS communicating component 442, etc., can receive the output of the CSI encoder that is based on training the ML model at the UE. As described, referring to timeline 1500 where reporting is over PUCCH, the first signaling can include MAC-CE or DCI 1502, 1504 in timeline 1500, which can indicate PUCCH resources, and network-side modeling component 452 can receive the CSI encoder output on the PUCCH resources that are at least T slots away (e.g., respectively in slots 1506, 1508). In another example, referring to timeline 1520 where reporting is over PUSCH, the first signaling can include MAC-CE or DCI 1522, 1524, 1526 in timeline 1520, which can respectively indicate resources or slots 1528, 1530, 1532 for reporting output of the CSI encoder. In this example, each iteration can be activated/triggered by the first signaling. The first iteration can be activated and/or triggered by the training process activation/triggering (e.g., by transmitting the configuration at Block 1602). This output can be used, in another example, to update the CSI decoder at Block 1606 and/or transmit the aggregated training gradient at Block 1608.

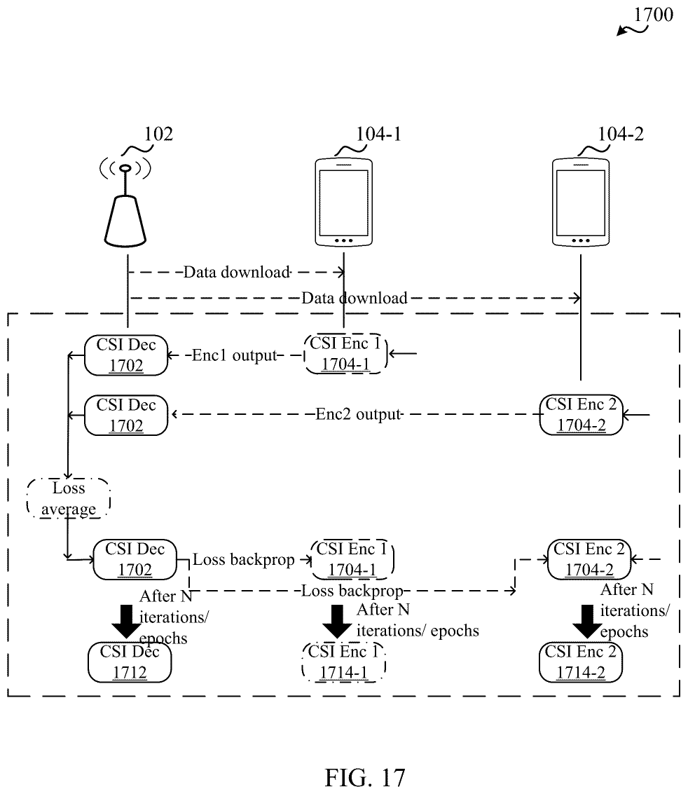

FIG. 17 illustrates an example of a network 1700 for performing joint ML model training of a CSI encoder at a UE and a CSI decoder at a network node. Network 1700 includes a base station 102 that can communicate with UEs 104-1, 104-2. UEs 104-1 and 104-2 can perform UE-side ML model training and report results to the base station 102, which can include the periodic or aperiodic training and/or reporting described above, and the base station 102 can perform network-side ML model training. Base station 102 can include a CSI decoding process 1702, UE 104-1 can include a CSI encoding process 1704-1, and UE 104-2 can include a CSI encoding process 1704-2. The base station 102 can transmit the configuration, which may include the configuration described above (e.g., in Block 1602), to the UE 104-1 and 104-2. UE 104-1 and UE 104-2 can download local data from a server. UEs 104-1 and 104-2 can independently do forward inference to obtain CSI encoding process 1704-1, 1704-2 output, and can respectively report outputs of the CSI encoding processes to the base station 102. The base station 102 can calculate loss (e.g., a loss average of the CSI encoder outputs received from UEs 104-1, 104-2) based on the reported outputs, use the loss to calculate a gradient to update its CSI decoding process 1702. The base station 102 can provide the gradient, back to the UEs 104-1 and 104-2 for respectively applying to the ML models for CSI encoding process 1704-1 and 1704-2. After a number of iterations (N) or epochs, the ML model training can be considered completed, and the base station can have CSI decoder 1712, and UEs 104-1 and 104-2 can have CSI encoders 1714-1 and 1714-2, which can be trained using similar ML models and thus provide similar encoding/decoding results. In addition, for example, UE servers may communicate with the base station 102 on behalf of UEs 104-1, 104-2 to compute the loss, provide the corresponding gradient, etc., as described above, to shift processing to the UE servers.

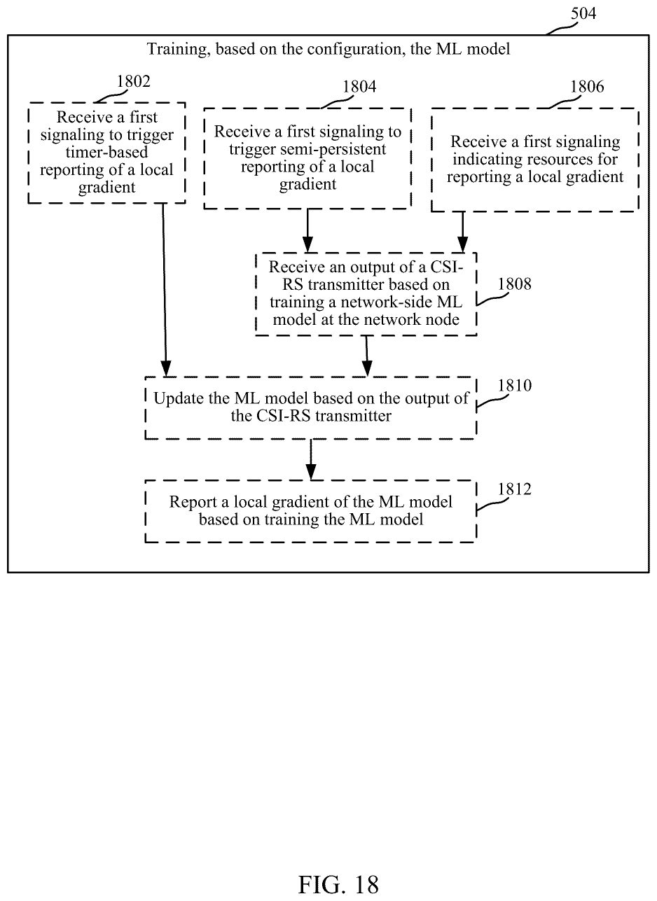

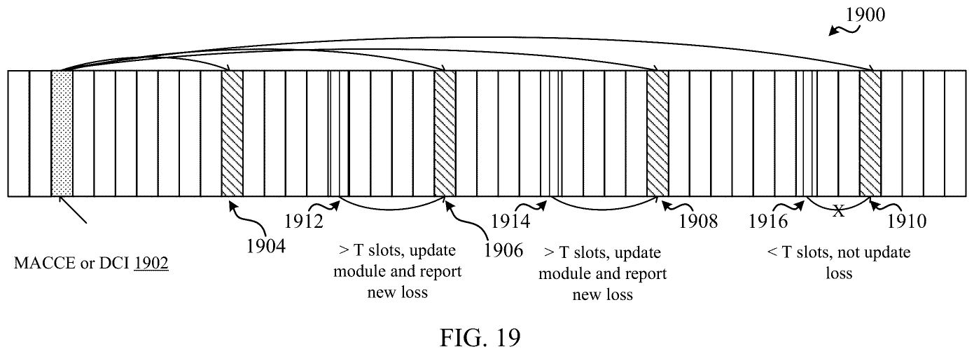

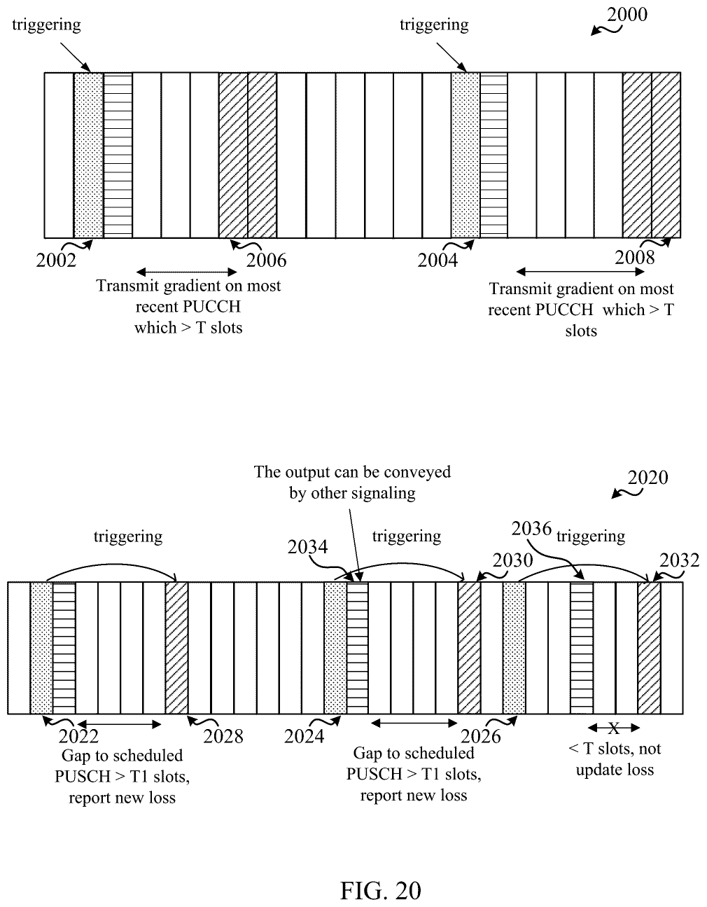

FIG. 18 illustrates an example of a process for performing joint training the ML model at the UE for performing channel estimation. In particular, for example, FIG. 18 illustrates additional Blocks for training, based on the configuration, the ML model, as described in Block 504 in FIG. 5. FIG. 19 illustrates an example of a timeline 1900 for signaling between the UE and network node for performing periodic training or reporting of a joint ML model for transmitting CSI-RS or performing channel estimation. FIG. 20 illustrates examples of timelines 2000, 2020 for signaling between the UE and network node for performing aperiodic training or reporting of a joint ML model for transmitting CSI-RS or performing channel estimation.

In training the ML model at Block 504, optionally at Block 1802, a first signaling to trigger timer-based reporting of a local gradient can be received. In an aspect, UE-side modeling component 352, e.g., in conjunction with processor(s) 312, memory 316, transceiver 302, UE communicating component 342, etc., can receive (e.g., from the network node) the first signaling to trigger timer-based reporting of a local gradient. For example, UE-side modeling component 352 can receive the first signaling as MAC-CE or dedicated DCI (e.g., MAC-CE or DCI 1902 in timeline 1900), which can indicate output of a CSI-RS transmitter of the network node (which can be based on a network-side ML model). The timer can be defined from the end of the CSI-RS transmitter output/training activation reception t₀ to the beginning of the local gradient reporting t₁. If the time from t₀ to t₁ is larger than the timer, UE-side modeling component 352 may refrain from training the UE-side ML model and/or refrain from reporting its local gradient, as described further herein.

In another example, in training the ML model at Block 504, optionally at Block 1804, a first signaling to trigger semi-persistent reporting of a local gradient can be received. In an aspect, UE-side modeling component 352, e.g., in conjunction with processor(s) 312, memory 316, transceiver 302, UE communicating component 342, etc., can receive (e.g., from the network node) the first signaling to trigger semi-persistent reporting of a local gradient. For example, UE-side modeling component 352 can receive the first signaling as MAC-CE or dedicated DCI (e.g., MAC-CE or DCI 1902 in timeline 1900), which can indicate periodic resources for reporting the local gradient (e.g., in resources or slots 1904, 1906, 1908, 1910 in timeline 1900). For example, the local gradient to report can be a local gradient of a ML model that is trained for performing channel estimation using CSI-RS transmissions received from the network node.

In another example, training the UE-side ML model and/or reporting the local gradient can be aperiodic. In this example, in training the ML model at Block 504, optionally at Block 1806, a first signaling indicating resources for reporting a local gradient can be received. In an aspect, UE-side modeling component 352, e.g., in conjunction with processor(s) 312, memory 316, transceiver 302, UE communicating component 342, etc., can receive (e.g., from the network node) the first signaling indicating resources for reporting the local gradient. For example, UE-side modeling component 352 can receive the first signaling as MAC-CE or dedicated DCI.

In training the ML model at Block 504, optionally at Block 1808, an output of a CSI-RS transmitter that is based on training a network-side ML model at the network node can be received. In an aspect, UE-side modeling component 352, e.g., in conjunction with processor(s) 312, memory 316, transceiver 302, UE communicating component 342, etc., can receive the output of the CSI-RS transmitter that is based on training the network-side ML model at the network node. For example, if the gradient report is on PUCCH, a dedicated PUCCH resource can be associated; alternatively, a list of candidate PUCCH resources can be configured, and selected PUCCH resource can be conveyed by the activation/triggering. For example, UE-side modeling component 352 can receive the output of the CSI-RS transmitter at slots 1912, 1914, 1916 in timeline 1900. In one example, UE-side modeling component 352 can receive the output of the CSI-RS encoder in MAC-CE or other higher layer signaling. The output can include the CSI-RS compression output (e.g., cover-code output) at the network node, which can then be used by UE-side modeling component 352 to calculate the gradient.

In training the ML model at Block 504, optionally at Block 1810, the ML model can be updated based on the output of the CSI-RS transmitter. In an aspect, UE-side modeling component 352, e.g., in conjunction with processor(s) 312, memory 316, transceiver 302, UE communicating component 342, etc., can update the ML model based on the CSI-RS transmitter, which can include refining the ML model for performing channel estimation, as described above. In this regard, the UE can continue to train the ML model at the UE-side based on CSI-RS transmitter output and can report local gradients back to the network node, as described herein.

In training the ML model at Block 504, optionally at Block 1812, a local gradient of the ML model can be reported based on training the ML model. In an aspect, UE-side modeling component 352, e.g., in conjunction with processor(s) 312, memory 316, transceiver 302, UE communicating component 342, etc., can report a local gradient of the ML model based on training the ML model. For example, UE-side modeling component 352 can transmit the local gradient in PUCCH or PUSCH resources, as described above and further herein, and the network node can use the local gradient to update its ML model for the CSI-RS transmitter. For example, UE-side modeling component 352 can report the local gradient within the timer. In another example, UE-side modeling component 352 can report the local gradient over configured semi-persistent or aperiodic resources.

In one example, however, UE-side modeling component 352 can refrain from updating its ML model based on the CSI-RS transmitter output and/or from reporting its local gradient when the output of the CSI-RS transmitter is received less than a number of slots (T) before the local gradient is to be reported. In an example, where the output of the CSI-RS transmitter is received in slot 1916, which is less than T slots before reporting slot 1910, UE-side modeling component 352 can accordingly determine to not update the ML model based on the output of the CSI-RS transmitter and/or to not report the local gradient in slot 1910.

For example, referring to timeline 2000 where reporting is over PUCCH, the first signaling can include MAC-CE or DCI 2002, 2004 in timeline 2000, which can indicate PUCCH resources, and UE-side modeling component 352 can determine to report the local gradient on the PUCCH resources that are at least T slots away (e.g., respectively in slots 2006, 2008).

In another example, referring to timeline 2020 where reporting is over PUSCH, the first signaling can include MAC-CE or DCI 2022, 2024, 2026 in timeline 2020, which can respectively indicate resources or slots 2028, 2030, 2032 for the local gradient. In this example, each iteration can be activated/triggered by the first signaling. The first iteration can be activated and/or triggered by the training process activation/triggering (e.g., by receiving the configuration at Block 502).

In this example, optionally at Block 1804, the output of the CSI-RS transmitter can be received, as described above. The output of CSI-RS compression (e.g., cover-code) can be indicated to UE using the same signaling or via a second signaling. The reporting content can include the gradient calculated using the indicated CSI-RS compression output at the network node. Practical impairment (e.g., modeled UE radio frequency (RF) impact) may be added to the CSI-RS compression output. In addition, in this example, optionally at Block 1806, the UE can update its ML model based on the CSI-RS transmitter output, as described above. In addition, optionally at Block 1808, the local gradient of the ML model based on training the ML model at the UE can be reported to the network node.

In this example of aperiodic reporting, where the UE-side modeling component 352 reports the local gradient on PUCCH, UE-side modeling component 352 can report the gradient on the most recent occasion of configured PUCCH that satisfies a timeline for model training (in terms of symbols after the activation/triggering command, as described above in reference to timeline 2000). Where UE-side modeling component 352 can report on PUSCH, the activation/triggering can be via a DL-DCI, which schedules a PUSCH carrying the local gradient report (as described above in reference to timeline 2020). In this example, the offset of the PUSCH relative to the DL-DCI can satisfy the timing for ML model training, as described above. This is shown, for example, for slot 2030, where the CSI-RS transmitter output is received at slot 2034, which is at least T1 slots from the reporting slot 2030, and UE-side modeling component 352 can accordingly report the local gradient at slot 2030. Otherwise if timing not satisfied, UE-side modeling component 352 can refrain from updating the ML model and/or reporting the local gradient. This is shown, for example, for slot 2032, where the CSI-RS transmitter output is received at slot 2036, which is less than T1 slots from the reporting slot 2032, and UE-side modeling component 352 can accordingly refrain from model training and/or reporting the local gradient at slot 2032. In addition, for example, the DL-DCI may be scrambled by a dedicated RNTI for ML model training.

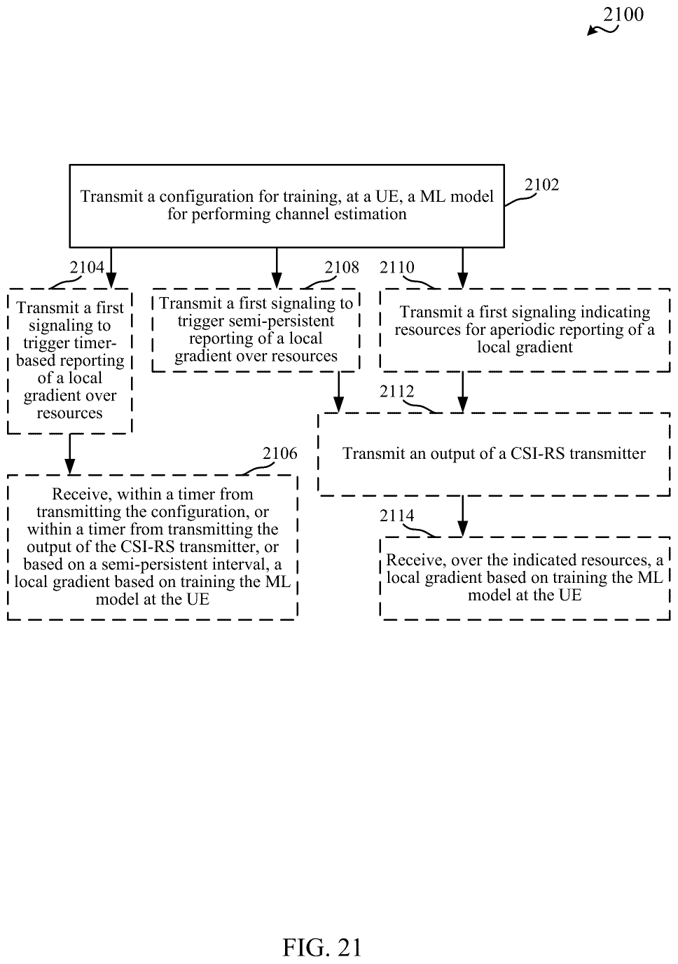

FIG. 21 illustrates a flow chart of an example of method 2100 for performing joint training the ML model at the network for transmitting CSI-RS, in accordance with aspects described herein. In an example, a network node, such as a base station 102 (e.g., a monolithic base station, one or more components of a disaggregated base station, etc.) can perform the functions described in method 2100 using one or more of the components described in FIGS. 1 and 4.

In method 2100, at Block 2102, a configuration for training, at a UE, a ML model for performing channel estimation can be transmitted. In an aspect, network-side modeling component 452, e.g., in conjunction with processor(s) 412, memory 416, transceiver 402, BS communicating component 442, etc., can transmit the configuration for training, at the UE (e.g., UE 104), the ML model for performing channel estimation, as described in Block 1202 of the method 1200 of FIG. 12.

In method 2100, optionally at Block 2104, a first signaling to trigger timer-based reporting of a local gradient can be transmitted. In an aspect, network-side modeling component 452, e.g., in conjunction with processor(s) 412, memory 416, transceiver 402, BS communicating component 442, etc., can transmit (e.g., to the UE 104) the first signaling to trigger timer-based reporting of a local gradient. For example, network-side modeling component 452 can transmit the first signaling as MAC-CE or dedicated DCI, as described above (e.g., in reference to timeline 1900 of FIG. 19). In one example, the first signaling can include an output of a CSI-RS transmitter or an activation for training based on the output of the CSI-RS transmitter. The timer can be defined from the end of the CSI-RS transmitter output/training activation reception t₀ to the beginning of the local gradient reporting t₁.

In method 2100, optionally at Block 2106, a local gradient that is based on training the ML model at the UE can be received within a timer from transmitting the configuration, or within a timer from transmitting the output of the CSI-RS, or based on a semi-persistent interval. In an aspect, network-side modeling component 452, e.g., in conjunction with processor(s) 412, memory 416, transceiver 402, BS communicating component 442, etc., can receive, within a timer from transmitting the configuration, or within a timer from transmitting the output of the CSI-RS, or based on a semi-persistent interval, a local gradient that is based on training the ML model at the UE. For example, network-side modeling component 452 can receive multiple local gradients from multiple UEs within the timer, and can update its CSI-RS transmitter based on the multiple local gradients, as described above. As described, for example, if all UEs in the set of UEs report the local gradient within the timer, network-side modeling component 452 can aggregate the local gradients from all the UEs in the set to train the network-side ML model or otherwise update the CSI-RS transmitter (e.g., determine the optimized cover code, beam, etc.), compute the total loss/gradient, etc. even where the timer has not expired. In another example, if the timer expires and one or more UEs in the set of UEs does not report the local gradient, the network-side modeling component 452 can update its CSI-RS transmitter based on the local gradients from the UEs who report within the timer. For example, network-side modeling component 452 can configure resources for receiving the local gradients in slots 1904, 1906, 1908, and 1910 in timeline 1900, but may not receive the local gradients in slot 1910 as the CSI-RS output may be transmitted in slot 1916, which I less than T slots from the reporting slot 1910.

In method 2100, optionally at Block 2108, a first signaling to trigger semi-persistent reporting of a local gradient can be transmitted. In an aspect, network-side modeling component 452, e.g., in conjunction with processor(s) 412, memory 416, transceiver 402, BS communicating component 442, etc., can transmit (e.g., to the UE 104) the first signaling to trigger semi-persistent reporting of a local gradient. For example, network-side modeling component 452 can transmit the first signaling as MAC-CE or dedicated DCI, as described above (e.g., in reference to timeline 1900 of FIG. 19). In one example, the first signaling can indicate or activate a semi-persistent interval for reporting the local gradient.

In another example, training the network-side ML model and/or receiving CSI encoder output reporting can be aperiodic, as described. In method 2100, optionally at Block 2110, a first signaling indicating resources for reporting of an aperiodic output of a local gradient can be transmitted. In an aspect, network-side modeling component 452, e.g., in conjunction with processor(s) 412, memory 416, transceiver 402, BS communicating component 442, etc., can transmit (e.g., to the UE 104) the first signaling to indicating resources for aperiodic reporting of a local gradient. As described, the first signaling can include MAC-CE or DCI 2022, 2024, 2026 that indicates resources 2028, 2030, 2032 for aperiodic reporting of the local gradient.

In method 2100, optionally at Block 2112, an output of a CSI-RS transmitter can be transmitted. In an aspect, CSI-RS component 456, e.g., in conjunction with processor(s) 412, memory 416, transceiver 402, BS communicating component 442, etc., can transmit the output of the CSI-RS transmitter. For example, CSI-RS component 456 can transmit the output of the CSI-RS transmitter before resources for reporting the local gradient, as described. For example, CSI-RS component 456 can transmit the CSI-RS output at slots 1912, 1914, 1916 in timeline 1900, as described, which may be transmitted using MAC-CE or other higher layer signaling.

In method 2100, optionally at Block 2114, a local gradient that is based on training the ML model at the UE can be received over the indicated resources. In an aspect, CSI decoding component 454, e.g., in conjunction with processor(s) 412, memory 416, transceiver 402, BS communicating component 442, etc., can receive, over the indicated resources, the local gradient that is based on training the ML model at the UE. For example, network-side modeling component 452 can receive multiple local gradients from multiple UEs within the timer, and can update its CSI-RS transmitter based on the multiple local gradients, as described above. In an example, the resources can include semi-persistently configured or aperiodically configured resources. For example, network-side modeling component 452 can configure semi-persistent resources for receiving the local gradients in slots 1904, 1906, 1908, and 1910 in timeline 1900, but may not receive the local gradients in slot 1910 as the CSI-RS output may be transmitted in slot 1916, which I less than T slots from the reporting slot 1910. In another example, network-side modeling component 452 can configure aperiodic resources for receiving the local gradients in slots 2006, 2008, 2028, 2030 in timeline 2000, but may not receive the local gradients in slot 2032 as the CSI-RS output may be transmitted in slot 2036, which I less than T slots from the reporting slot 2032.

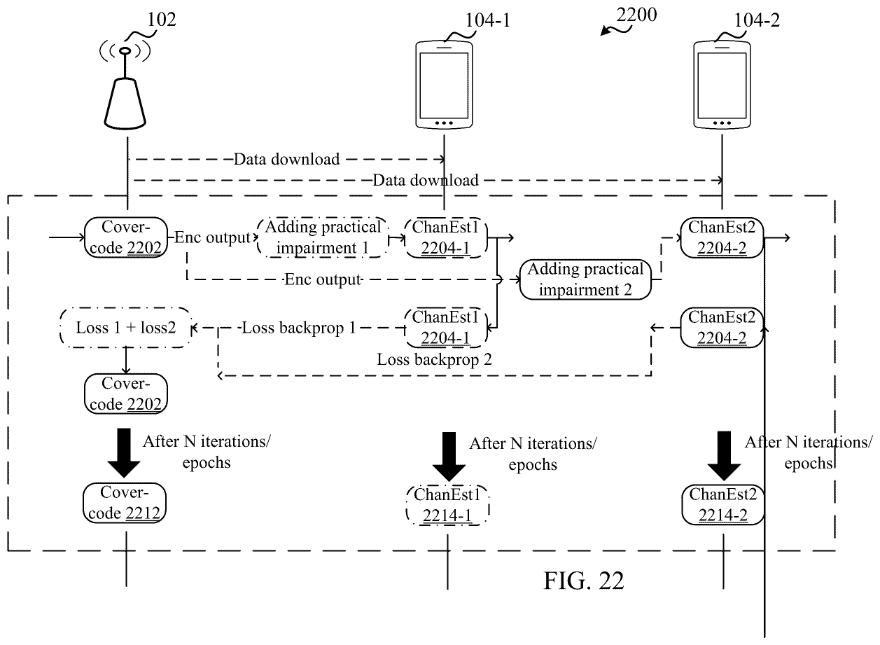

FIG. 22 illustrates an example of a network 2200 for performing joint ML model training of a CSI-RS transmitter at a network node and a channel estimation at a UE. Network 2200 includes a base station 102 that can communicate with UEs 104-1, 104-2. UEs 104-1 and 104-2 can perform UE-side ML model training and report results to the base station 102, which can include the periodic or aperiodic training and/or reporting described above, and the base station 102 can perform network-side ML model training. Base station 102 can include a cover code 2202 for transmitting CSI-RS, UE 104-1 can include a channel estimation process 2204-1, and UE 104-2 can include a channel estimation process 2204-2.

In an example, the base station 102 can transmit an output of the CSI-RS transmitter (e.g., a practical impairment) to UE 104-1 and UE 104-2. UEs 104-1 and 104-2 can use the output through their respective channel estimation process 2204-1 or 2204-2, and can respectively calculate a loss of the channel estimation processes. UEs 104-1 and 104-2 can use the loss to calculate a gradient for updating their respective channel estimation process 2204-1 or 2204-2, and can give the gradients back to the base station 102. The base station 102 can compute a total or aggregate gradient based on the gradients received from the UEs 104-1, 104-2, and can update the cover code 2202. After a number of iterations (N) or epochs, the ML model training can be considered completed, and the base station can have cover code 2212, and UEs 104-1 and 104-2 can have channel estimation processes 2214-1 and 2214-2, which can be trained using similar ML models and thus provide similar CSI-RS transmitting and corresponding channel estimation results. In addition, for example, UE servers may communicate with the base station 102 on behalf of UEs 104-1, 104-2 to compute the loss, provide the corresponding gradient, etc., as described above, to shift processing to the UE servers.

### Separate ML Model Training

In some examples, the UE and network node can independently train their own ML models, which may be based on a reference model. For example, the network node can train its ML model focusing on a reference UE-side model, and can send its trained module to a set of UEs (or UE servers, as described above). Each UE (or UE server) can train its own model using the provided network-side ML model. The training could be via local data or global data. For training at UE server, the UE server may deliver the trained module to corresponding UEs.

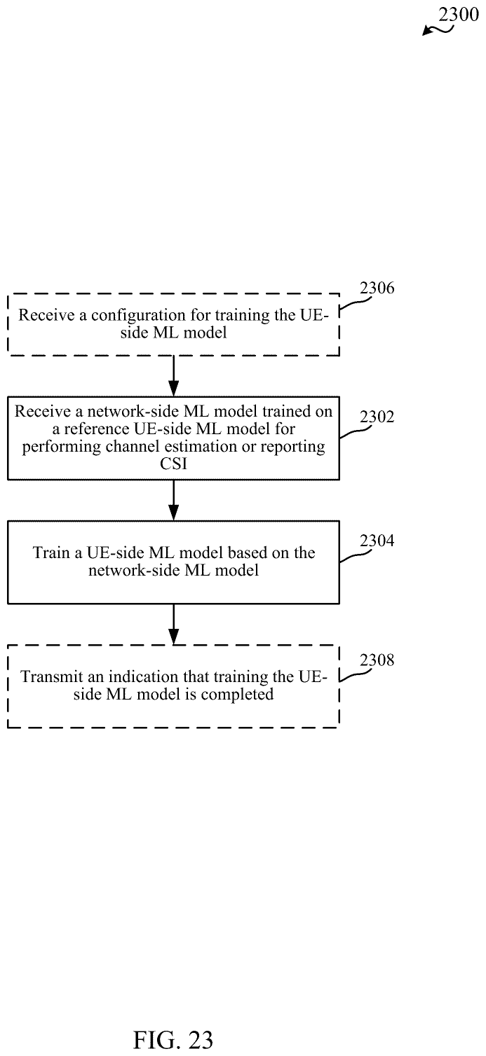

FIG. 23 illustrates a flow chart of an example of a method 2300 for using an ML model trained at a UE for performing channel estimation or encoding CSI, in accordance with aspects described herein. In an example, a UE 104 can perform the functions described in method 2300 using one or more of the components described in FIGS. 1 and 3.

In method 2300, at Block 2302, a network-side ML model trained on a reference UE-side ML model for performing channel estimation or reporting CSI can be received. In an aspect, UE-side modeling component 352, e.g., in conjunction with processor(s) 312, memory 316, transceiver 302, UE communicating component 342, etc., can receive the network-side ML model trained on the reference UE-side ML model for performing channel estimation or encoding or reporting CSI. For example, UE-side modeling component 352 can receive the network-side ML model from the network node in RRC or other higher layer signaling. In one example, UE-side modeling component 352 can receive, from the network node (e.g., for each training iteration), one or more of associated data set indices, the reference model (e.g., a CSI encoder ML model for encoding CSI feedback, and/or a channel estimation ML model for CSI-RS optimization), an associated network-side ML model (e.g., a CSI decoder ML model, and/or a CSI-RS transmission ML model), batch size b, number of epochs N, learning rate configuration, as described above, etc. As described, in one example, UE-side modeling component 352 may choose batch and/or can report the batch size to the network node. In addition, in one example, UE-side modeling component 352 can transmit, to the network node, a gradient of the ML model at the UE, and the network node can update its ML model based on the gradient (and gradients from other UEs).

In method 2300, at Block 2304, a UE-side ML model can be trained based on the network-side ML model. In an aspect, UE-side modeling component 352, e.g., in conjunction with processor(s) 312, memory 316, transceiver 302, UE communicating component 342, etc., can train the UE-side model based on the network-side ML model (and/or using data received from a server). As described, for example, UE-side modeling component 352 can train its ML model based on the associated data set indices, batch size, number of epochs, learning rate, etc.

In method 2300, optionally at Block 2306, a configuration for training the UE-side ML model can be received. In an aspect, UE-side modeling component 352, e.g., in conjunction with processor(s) 312, memory 316, transceiver 302, UE communicating component 342, etc., can receive (e.g., from the network node), the configuration for training the UE-side ML model. In one example, the configuration may include parameters described above other than the reference model, such as the associated data set indices, batch size, number of epochs, learning rate, etc. In an example, UE-side modeling component 352 can receive the configuration (and/or the reference model) in RRC or other higher layer signaling.

In method 2300, optionally at Block 2308, an indication that training the UE-side ML model is completed can be transmitted. In an aspect, UE-side modeling component 352, e.g., in conjunction with processor(s) 312, memory 316, transceiver 302, UE communicating component 342, etc., can transmit (e.g., to the network node) the indication that training the UE-side ML model is completed. For example, UE-side modeling component 352 can transmit the indication using a dedicated scheduling request (SR) or associated resources. In one example, the network node can transmit CSI-RS or determine to decode CSI feedback from the UE 104 based on receiving the indication. In addition, in this example, CSI encoding component 354 can start encoding CSI based on the ML model and/or channel estimating component 356 can begin estimating channels using optimized CSI-RS based on the ML model after transmitting the indication that model training is completed.

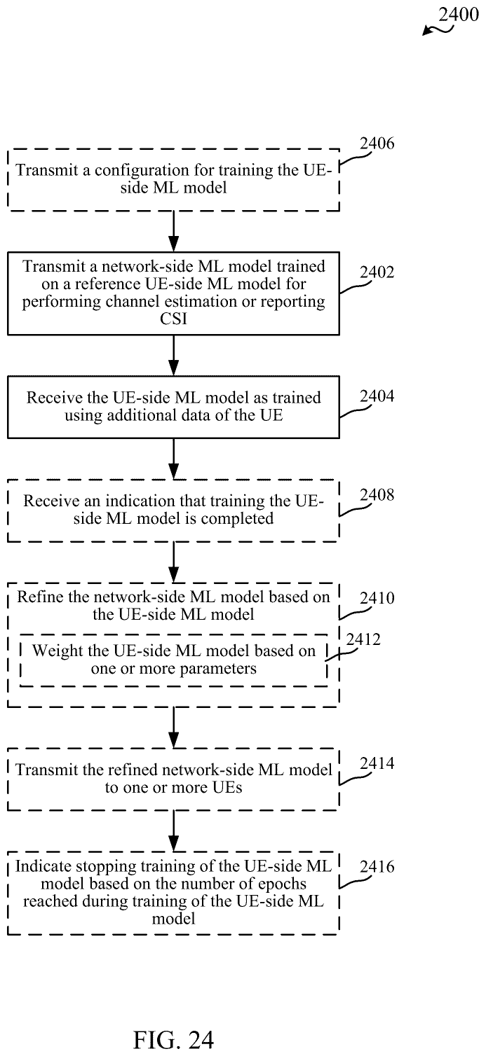

FIG. 24 illustrates a flow chart of an example of a method 2400 for using a ML model trained at a network node for performing CSI-RS transmission or decoding CSI, in accordance with aspects described herein. In an example, a network node, such as a base station 102 (e.g., a monolithic base station, one or more components of a disaggregated base station, etc.) can perform the functions described in method 2400 using one or more of the components described in FIGS. 1 and 4.

In method 2400, at Block 2402, a network-side ML model trained on a reference UE-side ML model for performing channel estimation or reporting CSI can be transmitted. In an aspect, network-side modeling component 452, e.g., in conjunction with processor(s) 412, memory 416, transceiver 402, BS communicating component 442, etc., can transmit (e.g., to the UE) the network-side ML model trained on the reference UE-side ML model that is for performing channel estimation or reporting CSI. For example, network-side modeling component 452 can transmit the network-side ML model in RRC or other higher layer signaling. In one example, network-side modeling component 452 can transmit (e.g., for each training iteration), one or more of associated data set indices, the reference model (e.g., a CSI encoder ML model for encoding CSI feedback, and/or a channel estimation ML model for CSI-RS optimization), an associated network-side ML model (e.g., a CSI decoder ML model, and/or a CSI-RS transmission ML model), batch size b, number of epochs N, learning rate configuration, as described above, etc. In addition, in one example, network-side modeling component 452 can receive, from one or more UEs, a gradient of the ML model at the UE, and the network-side modeling component 452 can update its ML model based on the gradients.

In method 2400, at Block 2404, the UE-side ML model as trained using additional data of the UE can be received. In an aspect, network-side modeling component 452, e.g., in conjunction with processor(s) 412, memory 416, transceiver 402, BS communicating component 442, etc., can receive (e.g., from the UE) the UE-side ML model as trained using the additional data of the UE. As described, for example, the UE can train its ML model based on the provided network side model received in the configuration, and/or based on additional data at the UE (e.g., as part of performing channel estimation or CSI encoding). The UE can transmit its UE-side ML model to the network node, as described.

In method 2400, optionally at Block 2406, a configuration for training the UE-side ML model can be transmitted. In an aspect, network-side modeling component 452, e.g., in conjunction with processor(s) 412, memory 416, transceiver 402, BS communicating component 442, etc., can transmit (e.g., to the UE) the configuration for training (and/or reporting) the UE-side ML model. As described, for example, network-side modeling component 452 can transmit the configuration in a RRC or other higher layer signaling to the UE 104. For example, the configuration may include parameters for performing, at the UE 104, ML model training of the model for performing channel estimation or encoding CSI. In one example, the configuration can include parameters described above, such as the associated data set indices, batch size, number of epochs, learning rate, etc. In an example, network-side modeling component 452 can transmit the configuration in RRC or other higher layer signaling.

In method 2400, optionally at Block 2408, an indication that training the UE-side ML model is completed can be received. In an aspect, network-side modeling component 452, e.g., in conjunction with processor(s) 412, memory 416, transceiver 402, BS communicating component 442, etc., can receive (e.g., from the UE) the indication that training the UE-side ML model is completed. For example, network-side modeling component 452 can receive the indication over a dedicated SR for the UE or associated resources. In one example, CSI decoding component 454 can decode CSI feedback and/or CSI-RS component 456 can optimize CSI-RS transmissions using the ML model based on receiving the indication.

In method 2400, optionally at Block 2410, the network-side ML model can be refined based on the UE-side ML model. In an aspect, network-side modeling component 452, e.g., in conjunction with processor(s) 412, memory 416, transceiver 402, BS communicating component 442, etc., can refine the network-side ML model based on the UE-side ML model. For example, network-side modeling component 452 can refine the network-side ML model based on parameters associated with the received UE-side ML model, parameters provided to the UE for training the UE-side ML model and/or the like. In one example, in refining the network-side ML model at 2410, optionally at Block 2412, the UE-side ML model can be weighted based on one or more parameters. In an aspect, network-side modeling component 452, e.g., in conjunction with processor(s) 412, memory 416, transceiver 402, BS communicating component 442, etc., can weight the UE-side ML model (and/or other UE-side ML models) for refining the network-side model based on the one or more parameters, which may include a batch size (e.g., as configured for the UE or reported by the UE, as described above).

In method 2400, optionally at Block 2414, the network-side ML model can be transmitted to one or more UEs. In an aspect, network-side modeling component 452, e.g., in conjunction with processor(s) 412, memory 416, transceiver 402, BS communicating component 442, etc., can transmit the refined network-side ML model to the one or more UEs. For example, network-side modeling component 452 can transmit the refined network-side ML model as described above in reference to transmitting the network-side ML model at Block 2402.

In method 2400, optionally at Block 2416, stopping training of the UE-side ML model can be indicated based on the number of epochs reached during training of the UE- side ML model. In an aspect, network-side modeling component 452, e.g., in conjunction with processor(s) 412, memory 416, transceiver 402, BS communicating component 442, etc., can indicate stopping training of the UE-side ML model based on the number of epochs reached during training of the UE-side ML model. For example, as described, the network node can determine that the number of epochs is reached, and network-side modeling component 452 can accordingly instruct the UE to stop training the UE-side ML model. Based on this, for example, the UE can begin using the ML model for channel estimation, CSI encoding, etc., the CSI decoding component 454 can begin decoding the CSI, CSI-RS component 456 can begin optimizing CSI-RS, and/or the like.

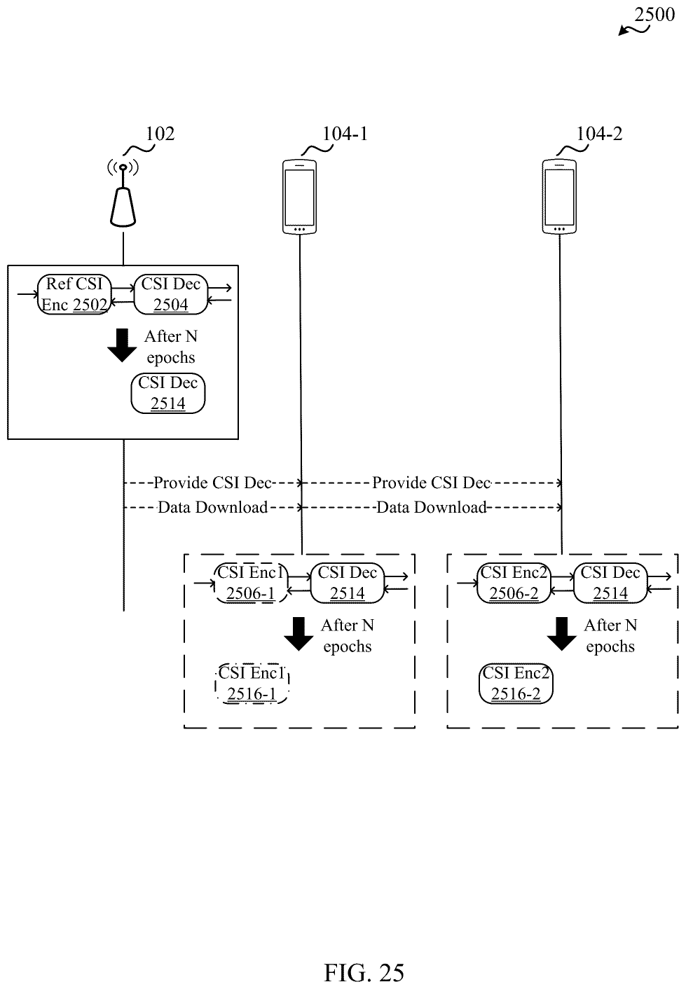

FIG. 25 illustrates an example of a network 2500 for performing separate ML model training of a CSI decoder at a network node and a CSI encoder at a UE. Network 2500 includes a base station 102 that can communicate with UEs 104-1, 104-2. Base station 102 can obtain a reference CSI encoder 2502 (e.g., from a UE) and can train the network-side ML model for the CSI decoder 2504. After a number of epochs N, base station 102 can produce CSI decoder 2514, which the base station 102 can provide to the UEs 104-1 and 104-2 along with data. UEs 104-1 and 104-2 can train their ML models for CSI encoders 2506-1 and 2506-2, respectively, based on the CSI decoder 2514 or related parameters. After N epochs, UE 104-1 can produce CSI encoder 2516-1 and UE 104-2 can produce CSI encoder 2516-2 trained on the ML model, which can be used for encoding CSI for transmitting to the base station 102.

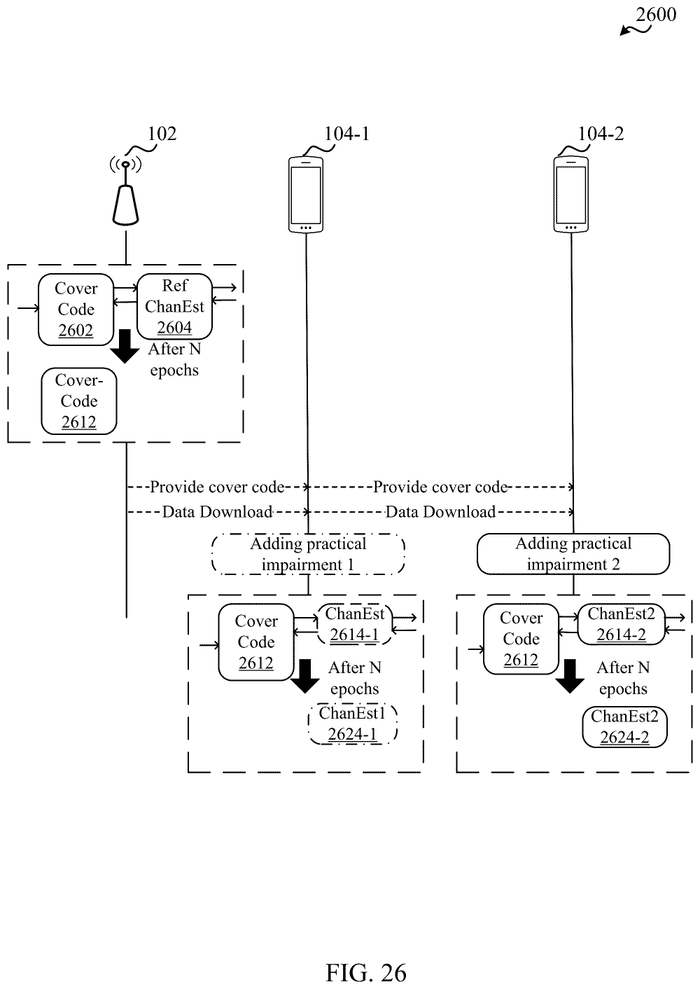

FIG. 26 illustrates an example of a network 2600 for performing separate ML model training of a cover code for transmitting CSI-RS at a network node and a channel estimation at a UE. Network 2600 includes a base station 102 that can communicate with UEs 104-1, 104-2. Base station 102 can obtain a reference channel estimation 2604 (e.g., from a UE) and can train the network-side ML model for the cover code 2602. After a number of epochs N, base station 102 can produce cover code 2612, which the base station 102 can provide to the UEs 104-1 and 104-2 along with data. UEs 104-1 and 104-2 can train their ML models for channel estimation 2614-1 and 2614-2, respectively, based on the cover code 2612 or related parameters, and/or based on adding practical impairments. After N epochs, UE 104-1 can produce channel estimation 2624-1 and UE 104-2 can produce channel estimation 2624-2 trained on the ML model, which can be used for performing channel estimation based on an optimized CSI-RS transmitted by the base station 102.

FIG. 27 is a block diagram of a MIMO communication system 2700 including a base station 102 and a UE 104. The MIMO communication system 2700 may illustrate aspects of the wireless communication access network 100 described with reference to FIG. 1. The base station 102 may be an example of aspects of the base station 102 described with reference to FIG. 1. The base station 102 may be equipped with antennas 2734 and 2735, and the UE 104 may be equipped with antennas 2752 and 2753. In the MIMO communication system 2700, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 2720 may receive data from a data source. The transmit processor 2720 may process the data. The transmit processor 2720 may also generate control symbols or reference symbols. A transmit MIMO processor 2730 may perform spatial processing (e.g., precoding) on data symbols, control symbols, or reference symbols, if applicable, and may provide output symbol streams to the transmit modulator/demodulators 2732 and 2733. Each modulator/demodulator 2732 through 2733 may process a respective output symbol stream (e.g., for OFDM, etc.) to obtain an output sample stream. Each modulator/demodulator 2732 through 2733 may further process (e.g., convert to analog, amplify, filter, and upconvert) the output sample stream to obtain a DL signal. In one example, DL signals from modulator/demodulators 2732 and 2733 may be transmitted via the antennas 2734 and 2735, respectively.

The UE 104 may be an example of aspects of the UEs 104 described with reference to FIGS. 1-2. At the UE 104, the UE antennas 2752 and 2753 may receive the DL signals from the base station 102 and may provide the received signals to the modulator/demodulators 2754 and 2755, respectively. Each modulator/demodulator 2754 through 2755 may condition (e.g., filter, amplify, downconvert, and digitize) a respective received signal to obtain input samples. Each modulator/demodulator 2754 through 2755 may further process the input samples (e.g., for OFDM, etc.) to obtain received symbols. A MIMO detector 2756 may obtain received symbols from the modulator/demodulators 2754 and 2755, perform MIMO detection on the received symbols, if applicable, and provide detected symbols. A receive (Rx) processor 2758 may process (e.g., demodulate, deinterleave, and decode) the detected symbols, providing decoded data for the UE 104 to a data output, and provide decoded control information to a processor 2780, or memory 2782.

The processor 2780 may in some cases execute stored instructions to instantiate a UE communicating component 342 (see e.g., FIGS. 1 and 2).

On the uplink (UL), at the UE 104, a transmit processor 2764 may receive and process data from a data source. The transmit processor 2764 may also generate reference symbols for a reference signal. The symbols from the transmit processor 2764 may be precoded by a transmit MIMO processor 2766 if applicable, further processed by the modulator/demodulators 2754 and 2755 (e.g., for SC-FDMA, etc.), and be transmitted to the base station 102 in accordance with the communication parameters received from the base station 102. At the base station 102, the UL signals from the UE 104 may be received by the antennas 2734 and 2735, processed by the modulator/demodulators 2732 and 2733, detected by a MIMO detector 2736 if applicable, and further processed by a receive processor 2738. The receive processor 2738 may provide decoded data to a data output and to the processor 2740 or memory 2742.

The processor 2740 may in some cases execute stored instructions to instantiate a BS communicating component 442 (see e.g., FIGS. 1 and 3).

The components of the UE 104 may, individually or collectively, be implemented with one or more ASICs adapted to perform some or all of the applicable functions in hardware. Each of the noted modules may be a means for performing one or more functions related to operation of the MIMO communication system 2700. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 2700.

The following aspects are illustrative only and aspects thereof may be combined with aspects of other embodiments or teaching described herein, without limitation.

Aspect 1 is a method for wireless communication at a UE including receiving, from a network node, a configuration for training a ML model for performing channel estimation or reporting channel state information, where the configuration indicates a data set for the ML model and one or more learning rate parameters; training, based on the configuration, the ML model, where the ML model performs at least one of: performing, based on the ML model, channel estimation of a channel between the UE and the network node; or reporting, based on the ML model, channel state information of the channel between the UE and the network node.

In Aspect 2, the method of Aspect 1 includes where the configuration indicates at least one of a batch size or number of epochs to use in training the ML model based on the data set.

In Aspect 3, the method of any of Aspects 1 or 2 includes where the one or more learning rate parameters include at least one of an initial learning rate, a learning rate decaying type, or a decaying ratio.

In Aspect 4, the method of any of Aspects 1 to 3 includes where the configuration indicates a loss function used for training the ML model.

In Aspect 5, the method of any of Aspects 1 to 4 includes where training the ML model includes performing multiple training iterations, the multiple training iterations including: an initial training iteration including reporting, to the network node and within a timer from receiving the configuration, a local training gradient associated with training the ML model; and one or more remaining training iterations including receiving a global gradient transmitted from the network node, updating the ML model based on the global gradient, and reporting an updated local training gradient associated with the updated ML model within the timer from receiving the global gradient.

In Aspect 6, the method of Aspect 5 includes reporting, to the network node, a timestamp associated with the local training gradient.

In Aspect 7, the method of Aspect 6 includes where the timestamp corresponds to at least one of a slot index of receiving the configuration, a slot index of receiving the global gradient, an iteration index of when the ML model is trained, or a timestamp received in the configuration.

In Aspect 8, the method of any of Aspects 1 to 7 includes receiving a first signaling to trigger a semi-persistent gradient reporting, where the semi-persistent gradient reporting comprises a plurality of reporting occasions, receiving, prior to each reporting occasion, a second signaling conveying global gradients, where a timing gap between the second signaling and a corresponding reporting occasion is greater than a threshold: updating the ML model based on the global gradients, and reporting a local gradient associated with the updated ML model, where the timing gap between the second signaling and the corresponding reporting occasion is not greater than a threshold: refraining from updating the ML model; and at least one of: refraining from reporting the local gradient; or reporting an outdated local gradient.

In Aspect 9, the method of any of Aspects 1 to 8 includes receiving, from the network node, downlink control information indicating resources for reporting an aperiodic local training gradient associated with training the ML model, and reporting, to the network node, the aperiodic local training gradient associated with training the ML model over the resources.

In Aspect 10, the method of Aspect 9 includes where training the ML model is based at least in part on a minimum timing gap between receiving the downlink control information and the resources for reporting the aperiodic local training gradient.

In Aspect 11, the method of any of Aspects 9 or 10 includes where the downlink control information is scrambled with a RNTI that indicates resources for reporting the aperiodic local training gradient.

In Aspect 12, the method of any of Aspects 9 to 11 includes receiving a second signaling conveying global gradients, where training the ML model is based on the global gradients, and where reporting the aperiodic local training gradient is based at least in part on a minimum timing gap between receiving the second signaling and the resources for reporting the aperiodic local training gradient.

In Aspect 13, the method of any of Aspects 1 to 12 includes reporting, to the network node and within a timer from receiving the configuration, an output of a CSI encoder based on training the ML model, receiving, from the network node, a global gradient transmitted from the network node, and updating the ML model based on the global gradient.

In Aspect 14, the method of Aspect 13 includes receiving, from the network node, downlink control information indicating resources for reporting the output of the CSI encoder.

In Aspect 15, the method of Aspect 14 includes where training the ML model is based at least in part on a minimum timing gap between receiving the downlink control information and the resources for reporting the output of the CSI encoder.

In Aspect 16, the method of any of Aspects 14 or 15 includes where the downlink control information is scrambled with a RNTI that indicates resources for reporting the output of the CSI encoder.

In Aspect 17, the method of any of Aspects 13 to 16 includes receiving a first signaling to trigger a semi-persistent reporting of an output of a CSI encoder, where the semi-persistent reporting comprises a plurality of reporting occasions, receiving, prior to each reporting occasion a second signaling conveying global gradients, where a timing gap between the second signaling and a reporting occasion is greater than a threshold, updating the ML model based on the global gradients, and where the timing gap between the second signaling and a corresponding reporting occasion of the plurality of reporting occasions is not greater than a threshold: refraining from updating the ML model.

In Aspect 18, the method of any of Aspects 1 to 17 includes receiving, from the network node, an output of a CSI-RS transmitter based on training a network-side ML model at the network node, updating the ML model based on a loss computed from the output of the CSI-RS transmitter, and reporting, to the network node, a local gradient of the ML model based on training the ML model.

In Aspect 19, the method of Aspect 18 includes receiving, from the network node, downlink control information indicating resources for reporting the local gradient.

In Aspect 20, the method of Aspect 19 includes where training the ML model is based at least in part on a minimum timing gap between receiving the downlink control information and the resources for reporting the local gradient.

In Aspect 21, the method of any of Aspects 19 or 20 includes where the downlink control information is scrambled with a RNTI that indicates resources for reporting the local gradient.

In Aspect 22, the method of any of Aspects 18 to 21 includes receiving a first signaling to trigger a semi-persistent reporting of a local gradient of the ML model based on training the ML model, where the semi-persistent reporting comprises a plurality of reporting occasions, receiving, prior to each reporting occasion, a second signaling conveying an output of a CSI-RS transmitter based on training a network-side ML model at the network node, where a timing gap between the second signaling and a corresponding reporting occasion is greater than a threshold, updating the ML model based on the output of the CSI-RS transmitter, and where the timing gap between the second signaling and the corresponding reporting occasion is not greater than a threshold: refraining from updating the ML model.

Aspect 23 is a method for wireless communication including transmitting a configuration for training, at a UE, a ML model for performing channel estimation or reporting channel state information, where the configuration indicates a data set for the ML model and one or more learning rate parameters, and where the ML model is used for at least one of channel estimation of a channel between the UE and a network node or CSI reporting of the channel between the UE and the network node.

In Aspect 24, the method of Aspect 23 includes where the configuration indicates at least one of a batch size or number of epochs to use in training the ML model based on the data set.

In Aspect 25, the method of any of Aspects 23 or 24 includes where the one or more learning rate parameters include at least one of an initial learning rate, a learning rate decaying type, or a decaying ratio.

In Aspect 26, the method of any of Aspects 23 to 25 includes where the configuration indicates a loss function to use in training the ML model.

In Aspect 27, the method of any of Aspects 23 to 26 includes receiving, within a timer from transmitting the configuration or within a timer from transmitting a global gradient, a training gradient associated with training the ML model at the UE.

In Aspect 28, the method of Aspect 27 includes transmitting, for multiple UEs including the UE, an aggregated global training gradient based at least in part on the training gradient and other received training gradients.

In Aspect 29, the method of Aspect 28 includes where the aggregated global training gradient is based on the training gradient and other received training gradients received within the timer, and where transmitting the aggregated global training gradient is based on the multiple UEs reporting the training gradient and the other received training gradients within the timer or expiration of the timer.

In Aspect 30, the method of any of Aspects 23 to 29 includes receiving a training gradient associated with training the ML model along with a timestamp.

In Aspect 31, the method of Aspect 30 includes transmitting, for multiple UEs including the UE, an aggregated training gradient based at least in part on applying a weight to the training gradient based on the timestamp.

In Aspect 32, the method of any of Aspects 30 or 31 includes where the timestamp corresponds to at least one of a slot index of transmitting the configuration, or a slot index of transmitting a global gradient, an iteration index of when the ML model is trained, or a timestamp transmitted in the configuration.

In Aspect 33, the method of any of Aspects 23 to 32 includes transmitting a trigger activating a semi-persistent local gradient reporting, where the semi-persistent local gradient reporting comprises a plurality of global gradient reporting instances.

In Aspect 34, the method of any of Aspects 23 to 33 includes receiving a training gradient associated with training the ML model at the UE, and transmitting a second signaling conveying an aggregated global gradient used for training the ML model, where a time gap between the second signaling and a next reporting occasion is greater than a threshold.

In Aspect 35, the method of any of Aspects 23 to 34 includes transmitting downlink control information indicating resources for reporting an aperiodic local training gradient associated with training the ML model, and receiving the aperiodic local training gradient associated with training the ML model at the UE over the resources.

In Aspect 36, the method of Aspect 35 includes where the downlink control information is scrambled with a RNTI that indicates resources for reporting the aperiodic local training gradient.

In Aspect 37, the method of any of Aspects 35 or 36 includes transmitting a second signaling conveying global gradients, and where receiving the aperiodic local training gradient is based at least in part on a minimum timing gap between transmitting the second signaling and the resources for reporting the aperiodic local training gradient.

In Aspect 38, the method of any of Aspects 23 to 37 includes receiving, within a timer from transmitting the configuration or within a timer from transmitting a global gradient, an output of a CSI encoder based on training a UE-side ML model at the UE.

In Aspect 39, the method of Aspect 38 includes updating, based on the output of the CSI encoder and other received outputs of other CSI encoders, the ML model for decoding channel state information, and transmitting, to multiple UEs including the UE, an aggregated global training gradient of an output of the ML model.

In Aspect 40, the method of Aspect 39 includes where the aggregated global training gradient is based on the output of the CSI encoder and the other received outputs of the other CSI encoders received within the timer, and where transmitting the aggregated global training gradient is based on the multiple UEs reporting the output of the CSI encoder and the other received outputs of the other CSI encoders within the timer or expiration of the timer.

In Aspect 41, the method of any of Aspects 39 or 40 includes transmitting a trigger activating a semi-persistent reporting of the output of the CSI encoder at multiple UEs.

In Aspect 42, the method of any of Aspects 38 to 41 includes transmitting, a second signaling conveying an aggregated global gradient used for training the UE-side ML model, where a time gap between the second signaling and a next reporting occasion is greater than a threshold

Aspect 43, the method of any of Aspects 38 to 42 includes transmitting downlink control information indicating resources for reporting the output of the CSI encoder.

In Aspect 44, the method of Aspect 43 includes where the downlink control information is scrambled with a RNTI that indicates resources for reporting the output of the CSI encoder.

In Aspect 45, the method of any of Aspects 43 or 44 includes transmitting a second signaling conveying global gradients, and where receiving the output of the CSI encoder is based at least in part on a minimum timing gap between transmitting the second signaling and the resources for reporting the output of the CSI encoder.

In Aspect 46, the method of any of Aspects 23 to 45 includes transmitting, to the UE, a global gradient of an output of a CSI-RS transmitter based on training the ML model; and receiving, within a timer from transmitting the configuration or within a timer from transmitting a global gradient, a local gradient of an output of a channel estimation based on training a UE-side ML model at the UE.

In Aspect 47, the method of Aspect 46 includes updating, based on the local gradient and other received local gradients, the ML model.

In Aspect 48, the method of Aspect 47 includes where updating the ML model is based on the local gradient and other received local gradients received within a timer.

In Aspect 49, the method of any of Aspects 46 or 47 includes transmitting a trigger activating a semi-persistent local gradient reporting, where the semi-persistent local gradient reporting comprises a plurality of global gradient reporting instances.

In Aspect 50, the method of any of Aspects 46 to 49 includes receiving a local gradient associated with training the UE-side ML model at the UE, and transmitting, a second signaling conveying an aggregated global gradient used for training the UE-side ML model, where a time gap between the second signaling and a next reporting occasion is greater than a threshold.

In Aspect 51, the method of any of Aspects 46 to 50 includes transmitting downlink control information indicating resources for reporting the local gradient associated with training the UE-side ML model.

In Aspect 52, the method of Aspect 51 includes where the downlink control information is scrambled with a RNTI that indicates resources for reporting the local gradient.

In Aspect 53, the method of any of Aspects 51 or 52 includes where receiving the local gradient is based at least in part on a minimum timing gap between transmitting the global gradient and the resources for reporting the local gradient.

Aspect 54 is a method for wireless communication including receiving, from a network node, a network-side ML model trained on a reference UE-side ML model for performing channel estimation or reporting channel state information, training a UE-side ML model using data received from a server and based on the network-side ML model, where the network-side ML model and UE-side ML model comprise at least one of: the network-side ML model used for CSI-RS transmission and the UE-side ML model used for channel estimation; or the network-side ML model used for CSI decoding and the UE- side ML model used for CSI encoding.

In Aspect 55, the method of Aspect 54 includes transmitting, to the network node, an indication that training the UE-side ML model is completed.

In Aspect 56, the method of any of Aspects 54 or 55 includes receiving, from the network node, a configuration for training the UE-side ML model, where the configuration indicates a data set for the UE-side ML model and one or more learning rate parameters.

In Aspect 57, the method of Aspect 56 includes where the configuration indicates at least one of a batch size or number of epochs to use in training the UE-side ML model based on the data set.

In Aspect 58, the method of any of Aspects 56 or 57 includes where the one or more learning rate parameters include at least one of an initial learning rate, a learning rate decaying type, or a decaying ratio.

In Aspect 59, the method of any of Aspects 56 to 58 includes where the configuration indicates the network-side ML model.

In Aspect 60, the method of any of Aspects 56 to 59 includes where the configuration indicates a loss function for training the UE-side ML model.

Aspect 61 is a method for wireless communication including transmitting a network-side ML model trained on a reference UE-side ML model for performing channel estimation or reporting channel state information, and where the ML model is used for at least one of channel estimation of the channel between a UE and a network node or CSI reporting of the channel between the UE and the network node.

In Aspect 62, the method of Aspect 61 includes receiving, from the UE,, an indication that training the UE-side ML model is completed.

In Aspect 63, the method of Aspect 62 includes refining the network-side ML model based on the UE-side ML model as trained using additional data of the UE, and transmitting the refined network-side ML model to one or more UEs.

In Aspect 64, the method of Aspect 63 includes receiving a batch size of the additional data of the UE used to train the UE-side ML model, where refining the network-side ML model is based on weighting the UE-side ML model according to the batch size.

In Aspect 65, the method of any of Aspects 62 to 64 includes transmitting a configuration for training the UE-side ML model, where the configuration indicates a data set for the UE-side ML model and one or more learning rate parameters.

In Aspect 66, the method of Aspect 65 includes where the configuration indicates at least one of a batch size or number of epochs to use in training the UE-side ML model based on the data set.

In Aspect 67, the method of Aspect 66 includes indicating stopping training of the UE-side ML model based on the number of epochs reached during the training of the UE-side ML model.

In Aspect 68, the method of any of Aspects 65 to 67 includes where the one or more learning rate parameters include at least one of an initial learning rate, a learning rate decaying type, or a decaying ratio.

In Aspect 69, the method of any of Aspects 65 to 68 includes where the configuration indicates the network-side ML model.

In Aspect 70, the method of any of Aspects 65 to 69 includes where the configuration indicates a loss function for training the UE-side ML model.

Aspect 71 is an apparatus for wireless communication including a transceiver, a memory configured to store instructions, and one or more processors communicatively coupled with the memory and the transceiver, where the one or more processors are configured to execute the instructions to cause the apparatus to perform any of the methods of Aspects 1 to 70.

Aspect 72 is an apparatus for wireless communication including means for performing any of the methods of Aspects 1 to 70.

Aspect 73 is a computer-readable medium including code executable by one or more processors for wireless communications, the code including code for performing any of the methods of Aspects 1 to 70.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for wireless communication at a user equipment (UE), comprising:
receiving, from a network node, a configuration for training a machine learning (ML) model for performing channel estimation or reporting channel state information, wherein the configuration indicates a data set for the ML model and one or more learning rate parameters; and
training, based on the configuration, the ML model, wherein the ML model performs
at least one of:
performing, based on the ML model, channel estimation of a channel between the UE and the network node; or
reporting, based on the ML model, channel state information of the channel between the UE and the network node.

2. The method of claim 1, wherein the configuration indicates at least one of a batch size or number of epochs to use in training the ML model based on the data set.

3. The method of claim 1, wherein the one or more learning rate parameters include at least one of an initial learning rate, a learning rate decaying type, or a decaying ratio.

4. The method of claim 1, wherein the configuration indicates a loss function used for training the ML model.

5. The method of claim 1, wherein training the ML model includes performing multiple training iterations, the multiple training iterations comprising:
an initial training iteration including reporting, to the network node and within a timer from receiving the configuration, a local training gradient associated with training the ML model; and
one or more remaining training iterations including receiving a global gradient transmitted from the network node, updating the ML model based on the global gradient, and reporting an updated local training gradient associated with the updated ML model within the timer from receiving the global gradient.

6. The method of claim 5, further comprising reporting, to the network node, a timestamp associated with the local training gradient, wherein the timestamp corresponds to at least one of a slot index of receiving the configuration, a slot index of receiving the global gradient, an iteration index of when the ML model is trained, or a timestamp received in the configuration.

7. The method of claim 1, further comprising:
receiving a first signaling to trigger a semi-persistent gradient reporting, wherein the semi-persistent gradient reporting comprises a plurality of reporting occasions;
receiving, prior to each reporting occasion, a second signaling conveying global gradients;
where a timing gap between the second signaling and a corresponding reporting occasion is greater than a threshold:
updating the ML model based on the global gradients; and
reporting a local gradient associated with the updated ML model;
where the timing gap between the second signaling and the corresponding reporting occasion is not greater than a threshold:
refraining from updating the ML model; and at least one of:
refraining from reporting the local gradient; or
reporting an outdated local gradient.

8. The method of claim 1, further comprising:
receiving, from the network node, downlink control information indicating resources for reporting an aperiodic local training gradient associated with training the ML model; and
reporting, to the network node, the aperiodic local training gradient associated with training the ML model over the resources.

9. The method of claim 8, wherein training the ML model is based at least in part on a minimum timing gap between receiving the downlink control information and the resources for reporting the aperiodic local training gradient.

10. The method of claim 1, further comprising:
reporting, to the network node and within a timer from receiving the configuration, an output of a channel state information (CSI) encoder based on training the ML model;
receiving, from the network node, a global gradient transmitted from the network node; and
updating the ML model based on the global gradient.

11. The method of claim 10, further comprising receiving, from the network node, downlink control information indicating resources for reporting the output of the CSI encoder, wherein training the ML model is based at least in part on a minimum timing gap between receiving the downlink control information and the resources for reporting the output of the CSI encoder.

12. The method of claim 10, further comprising:
receiving a first signaling to trigger a semi-persistent reporting of an output of a channel state information (CSI) encoder, wherein the semi-persistent reporting comprises a plurality of reporting occasions;
receiving, prior to each reporting occasion a second signaling conveying global gradients;
where a timing gap between the second signaling and a reporting occasion is greater than a threshold:
updating the ML model based on the global gradients; and
where the timing gap between the second signaling and a corresponding reporting occasion of the plurality of reporting occasions is not greater than a threshold:
refraining from updating the ML model.

13. The method of claim 1, further comprising:
receiving, from the network node, an output of a channel state information (CSI)-reference signal (RS) transmitter based on training a network-side ML model at the network node;
updating the ML model based on a loss computed from the output of the CSI-RS transmitter; and
reporting, to the network node, a local gradient of the ML model based on training the ML model.

14. The method of claim 13, further comprising receiving, from the network node, downlink control information indicating resources for reporting the local gradient, wherein training the ML model is based at least in part on a minimum timing gap between receiving the downlink control information and the resources for reporting the local gradient.

15. The method of claim 13, further comprising:
receiving a first signaling to trigger a semi-persistent reporting of a local gradient of the ML model based on training the ML model, wherein the semi-persistent reporting comprises a plurality of reporting occasions;
receiving, prior to each reporting occasion, a second signaling conveying an output of a channel state information (CSI)-reference signal (RS) transmitter based on training a network-side ML model at the network node;
where a timing gap between the second signaling and a corresponding reporting occasion is greater than a threshold:
updating the ML model based on the output of the CSI-RS transmitter; and
where the timing gap between the second signaling and the corresponding reporting occasion is not greater than a threshold:
refraining from updating the ML model.

16. A method for wireless communication, comprising:
transmitting a configuration for training, at a user equipment (UE), a machine learning (ML) model for performing channel estimation or reporting channel state information, wherein the configuration indicates a data set for the ML model and one or more learning rate parameters; and
wherein the ML model is used for at least one of channel estimation of a channel between the UE and a network node or CSI reporting of the channel between the UE and the network node.

17. The method of claim 16, wherein the configuration indicates at least one of a batch size or number of epochs to use in training the ML model based on the data set, wherein the one or more learning rate parameters include at least one of an initial learning rate, a learning rate decaying type, or a decaying ratio, or wherein the configuration indicates a loss function to use in training the ML model.

18. The method of claim 16, further comprising:
receiving, within a timer from transmitting the configuration or within a timer from transmitting a global gradient, a training gradient associated with training the ML model at the UE; and
transmitting, for multiple UEs including the UE, an aggregated global training gradient based at least in part on the training gradient and other received training gradients,
wherein the aggregated global training gradient is based on the training gradient and other received training gradients received within the timer, and
wherein transmitting the aggregated global training gradient is based on the multiple UEs reporting the training gradient and the other received training gradients within the timer or expiration of the timer.

19. The method of claim 16, further comprising:
receiving a training gradient associated with training the ML model along with a timestamp; and
transmitting, for multiple UEs including the UE, an aggregated training gradient based at least in part on applying a weight to the training gradient based on the timestamp,
wherein the timestamp corresponds to at least one of a slot index of transmitting the configuration, or a slot index of transmitting a global gradient, an iteration index of when the ML model is trained, or a timestamp transmitted in the configuration.

20. The method of claim 16, further comprising transmitting a trigger activating a semi-persistent local gradient reporting, wherein the semi-persistent local gradient reporting comprises a plurality of global gradient reporting instances, and further comprising:
receiving a training gradient associated with training the ML model at the UE; and
transmitting a second signaling conveying an aggregated global gradient used for training the ML model, wherein a time gap between the second signaling and a next reporting occasion is greater than a threshold.

21. The method of claim 16, further comprising:
transmitting downlink control information indicating resources for reporting an aperiodic local training gradient associated with training the ML model; and
receiving the aperiodic local training gradient associated with training the ML model at the UE over the resources.

22. The method of claim 16, further comprising:
receiving, within a timer from transmitting the configuration or within a timer from transmitting a global gradient, an output of a channel state information (CSI) encoder based on training a UE-side ML model at the UE;
updating, based on the output of the CSI encoder and other received outputs of other CSI encoders, the ML model for decoding channel state information; and
transmitting, to multiple UEs including the UE, an aggregated global training gradient of an output of the ML model.

23. The method of claim 16, further comprising:
transmitting, to the UE, a global gradient of an output of a channel state information (CSI)-reference signal (RS) transmitter based on training the ML model; and
receiving, within a timer from transmitting the configuration or within a timer from transmitting a global gradient, a local gradient of an output of a channel estimation based on training a UE-side ML model at the UE; and
updating, based on the local gradient and other received local gradients, the ML model.

24. A method for wireless communication, comprising:
receiving, from a network node, a network-side machine learning (ML) model trained on a reference user equipment (UE)-side ML model for performing channel estimation or reporting channel state information;
training a UE-side ML model using data received from a server and based on the network-side ML model, wherein the network-side ML model and UE-side ML model comprise at least one of:
the network-side ML model used for channel state information (CSI)-reference signal (RS) transmission and the UE-side ML model used for channel estimation; or
the network-side ML model used for CSI decoding and the UE-side ML model used for CSI encoding.

25. The method of claim 24, further comprising transmitting, to the network node, an indication that training the UE-side ML model is completed.

26. The method of claim 24, further comprising receiving, from the network node, a configuration for training the UE-side ML model, wherein the configuration indicates a data set for the UE-side ML model and one or more learning rate parameters.

27. The method of claim 26, wherein the configuration indicates at least one of a batch size or number of epochs to use in training the UE-side ML model based on the data set, wherein the one or more learning rate parameters include at least one of an initial learning rate, a learning rate decaying type, or a decaying ratio, wherein the configuration indicates the network-side ML model, or wherein the configuration indicates a loss function for training the UE-side ML model.

28. A method for wireless communication, comprising:
transmitting a network-side machine learning (ML) model trained on a reference user equipment (UE)-side ML model for performing channel estimation or reporting channel state information; and
wherein the ML model is used for at least one of channel estimation of the channel between a UE and a network node or CSI reporting of the channel between the UE and the network node.

29. The method of claim 28, further comprising receiving, from the UE,, an indication that training the UE-side ML model is completed.

30. The method of claim 29, further comprising:
refining the network-side ML model based on the UE-side ML model as trained using additional data of the UE; and
transmitting the refined network-side ML model to one or more UEs.
